(19) United States
(12) Patent Application Publication
(10) Pub. No.: US 2011/0199625 A1
(43) Pub. Date: Aug. 18, 2011

(54) PRINT DATA GENERATION APPARATUS, PRINTING APPARATUS AND PROGRAM

(75) Inventors: Yasuaki SUGIMOTO, Tokyo (JP); Masaki Kakutani, Hiratsuka-shi (JP); Yukihiko Ichikawa, Tokyo (JP); Masao Akimoto, Tokyo (JP)

(73) Assignee: KONICA MINOLTA BUSINESS TECHNOLOGIES, INC., Tokyo (JP)

(21) Appl. No.: 13/023,690

(22) Filed: Feb. 9, 2011

(30) Foreign Application Priority Data
Feb. 18, 2010 (JP) JP2010-033233

(51) Int. Cl. H04N 1/60

(52) U.S. Cl. 358/1.9

(57) ABSTRACT

A print data generation apparatus for generating a print data which causes an image indicated to be printed and a first mark, being printed by using a color erasable print material whose color is erasable by exposing to specific wavelength light, to be printed on a same recording sheet.

### CROSS REFERENCE TO RELATED APPLICATION

The present application is based on Japanese Patent Application No. 2010-033233 filed with Japanese Patent Office on Feb. 18, 2010, the entire content of which is hereby incorporated by reference.

### BACKGROUND OF THE INVENTION

1. Technical Field

The present invention relates to a print data generation apparatus for forming a print material provided with a duplication restraining function, printing apparatus and a program.

2. Background Technology

As a technology for restraining an illegal copying regarding original documents and confidential documents, a grand pattern technology has been known, where characters such as “Copy” indicating a trace of copying are embedded in the ground pattern constituting a background of the document as hidden characters (latent image), and in cases where this document is copied the characters indicating the trace of copying appear to exert the duplication restraining effect (please refer to Unexamined Japanese Patent Application Publication No. 2006-121518).

On the other hand, in the field of printing toner, a color erasable toner has been known whose color disappears (becomes colorless) when being exposed with near-infrared light. A copying machine which executes copying of an original document using the color erasable toner has been proposed (refer to Unexamined Japanese Patent Application Publication H05-69675).

Although the common conventional ground pattern printing technology intends to exert a psychological restraining effect, by making the hidden characters on the original document appear on the printed material as a trace (or evidence), it cannot be determined whether copying is executed or not from the original document itself since the trace of copying does not remain on the original document. For example, in cases of circulating a confidential document strictly prohibited from duplication in an office, it is impossible to determine from the document itself that the document has not been copied. Therefore, this technology has a room to be improved as the duplication restraining technology.

The copying machine utilizing the color erasable toner, for example, may be applied to the copy of confidential document to make contents of the printed document erasable in order to prevent leaking of confidential information. However, even in cases when the document is copied by using this copying machine, it is impossible to find out the trace of copying from the document itself.

The present invention intends to solve the above-described problems, and objective of the present invention is to provide a print data generation apparatus, for forming a print material provided with a duplication restraining function, printing apparatus and a program, in which the fact that reading is executed by an image reading apparatus irradiating specific wavelength light on the original document at the time of reading the original document image is distinguished by the printed material of the original document itself, and duplication of the original document can be restrained.

### SUMMARY

In order to achieve the above described object, embodiments reflecting at least one aspect of the present invention are as follows.

(1) A print data generation apparatus characterized in that the apparatus generates print data which causes an image indicated to be printed and a first mark to be printed on a same recording sheet, wherein the first mark is printed by using a color erasable print material whose color is erasable by exposing to specific wavelength light.

According to the above embodiment, based on the print data generated by the print data generation apparatus, a printing apparatus prints and outputs the image indicated to be printed and the first mark on the same recording sheet. In this printing, the first mark is printed on the recording sheet by use of the color erasable print material whose color is erasable by exposing to a specific wavelength light. The first mark may be configured with various marks including, for example, a character, a sign or a graphic (geometric pattern) and the like.

(2) The print data generation apparatus according to (1) characterized in that the apparatus generates the print data further causes a second mark, being printed by using a color un-erasable print material whose color is not erasable by exposing to the specific wavelength light, to be printed on the same recording sheet.

According to the above embodiment, the printing apparatus outputs the recording sheet by printing the image indicated to be printed, the first mark and the second mark on the same recording sheet. In this printing, the second mark is printed by using a color un-erasable print material whose color is not erasable by exposing to said specific wavelength light. In cases where the specific wavelength light is irradiated at the time of image reading of this printed material (recording sheet), the first mark is erased and the second mark remains without being erased from the printed material.

### BRIEF DESCRIPTION OF THE DRAWINGS

These and other objects, advantages and features of the invention will become apparent from the following description thereof taken in conjunction with the accompanying drawings in which:

FIG. 1 is a drawing illustrating a configuration of a system relating to the first embodiment of the present invention where a terminal apparatus and a MFP (Multi Function Peripheral) are connected;

FIG. 2 is a block diagram illustrating an outline structure of the terminal apparatus relating to the first embodiment of the present invention;

FIG. 3 is a block diagram illustrating an outline structure of the MFP relating to the first embodiment of the present invention;

FIGS. 4A and 4B are diagrams illustrating an outline structure of the scanner section provided to the MFP;

FIG. 5 is a flow diagram illustrating the flow while printing of a document added with a erasable mark is requested from the terminal apparatus, and the MFP outputs the printed material;

FIG. 6 is a flow diagram illustrating operations by the terminal apparatus for requesting a printing of document;

FIG. 7 is a flow diagram illustrating printing operations of the document by the MFP having received the request;

FIG. 8 is a diagram illustrating a flow of copying the original document by the MFP for outputting a printed material added with an erasable mark;

FIG. 9 is a flow diagram illustrating operations of copying the original document by the MFP for outputting a printed material added with an erasable mark;

FIG. 10 is a diagram illustrating an original document added with the erasable mark, a readout image acquired when this original document being read by the MFP, and an original document after having been read;

FIG. 11 is a flow diagram illustrating reading operations of the original document by the MFP;

FIG. 12 is a timing chart illustrating put-on/put-off timing of a light source and reading timing of the original document in the original document reading operation;

FIG. 13 is a diagram illustrating an original document added with an erasable mark, and the original after having been read in the case where this original document was read halfway;

FIG. 14 is a diagram illustrating the original document having been read in FIG. 13;

FIG. 15 is a diagram illustrating a flow where the printing of document added with an erasable mark and an un-erasable mark is requested from the terminal apparatus relating to the second embodiment of the present invention, and the MFP outputs the printed material;

FIG. 16 is a diagram illustrating an obtained readout image and an original document after having been read in a case when the MFP reads an original added with an erasable mark and an un-erasable mark;

FIG. 17 is a diagram illustrating an example when the added position of un-erasable mark is different from that in FIG. 15;

FIG. 18 is a diagram illustrating an obtained readout image and an original document after having been read in a case when the MFP reads an original added with an erasable mark and an un-erasable mark shown in FIG. 17;

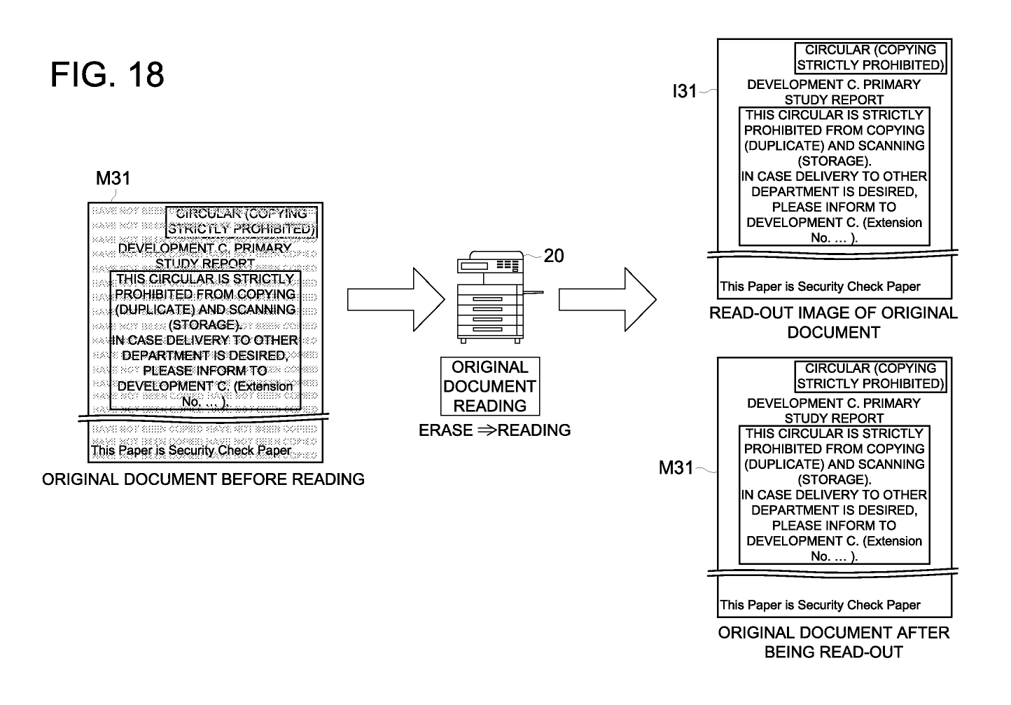

FIG. 19 is a diagram illustrating an example when the un-erasable mark is added on the back side of the print material;

FIG. 20 is a diagram illustrating an example when the un-erasable mark is added at a vacant area of the print material;

FIG. 21 is a diagram illustrating an outline of conventional ground pattern printing technology;

FIG. 22 is a diagram illustrating in enlarged image of the dots constituting each of the ground pattern image printed on an original document by the conventional ground pattern printing technology, the readout image of the original document, and the ground pattern image of the original document after having been read;

FIG. 23 is a diagram illustrating examples of an original document added with ground pattern image by a conventional printing technology, the readout image of this original document, and the original document after having been read;

FIG. 24 is a diagram illustrating in enlarged image of the dots constituting each of the ground pattern image printed on an original document by the ground pattern printing technology relating to the third embodiment of the present invention, the readout image of the original document, and the ground pattern image of the original document after having been read;

FIG. 25 is a diagram illustrating examples of a readout image in a case of reading the original document added with ground pattern image by the ground pattern printing technology relating to the third embodiment of the present invention, and the original document after having been read;

FIG. 26 is a diagram illustrating adding patterns in a view in cases where the erasable mark relating to the first embodiment of the present invention and the ground pattern mark relating to the third embodiment are added on the printed material;

FIG. 27 is a timing chart showing the put-on/put-off timing of the light source and the reading-out timing of the original document in original document reading operation in the patterns (f) and (g) of FIG. 26;

FIG. 28 is a diagram illustrating examples of the original document printed with a ground pattern mark of adding patterns (f) and (g) of FIG. 26, the readout image in the case where this original document is read by the reading operation shown with the timing chart of FIG. 27, and the original document after having been read;

FIG. 29 is a diagram illustrating other examples of ground pattern mark relating to the third embodiment of the present invention;

FIG. 30 is a diagram illustrating examples of assimilated mark relating to the third embodiment of the present invention;

FIG. 31 is a diagram illustrating examples of non-assimilated mark relating to the third embodiment of the present invention;

FIG. 32 is a diagram illustrating an example when the assimilated mark and the non-assimilated mark relating to the third embodiment of the present invention are combined;

FIG. 33 is a flow chart showing a print request operation of a document by a terminal apparatus relating to the fourth embodiment of the present invention;

FIG. 34 is a flow chart showing the subroutine of security output setting process in the flow of FIG. 33;

FIG. 35 is a diagram illustrating an example of print setting screen displayed in a terminal apparatus;

FIG. 36 is a diagram illustrating an example of print setting screen displayed in the terminal apparatus;

FIG. 37 is a diagram illustrating an example of print setting screen displayed in the terminal apparatus;

FIG. 38 is a diagram illustrating an example of print setting screen displayed in the terminal apparatus;

FIG. 39 is a diagram illustrating an example of print setting screen displayed in the terminal apparatus;

FIG. 40 is a diagram illustrating an example of print setting screen displayed in the terminal apparatus;

FIG. 41 is a diagram illustrating an example of print setting screen displayed in the terminal apparatus; and

FIG. 42 is a diagram illustrating an example of print setting screen displayed in the terminal apparatus.

### DETAILED DESCRIPTION OF THE PREFERRED EMBODIMENTS

Hereinafter, embodiments of the present invention will be described based on the drawings.

### First Embodiment

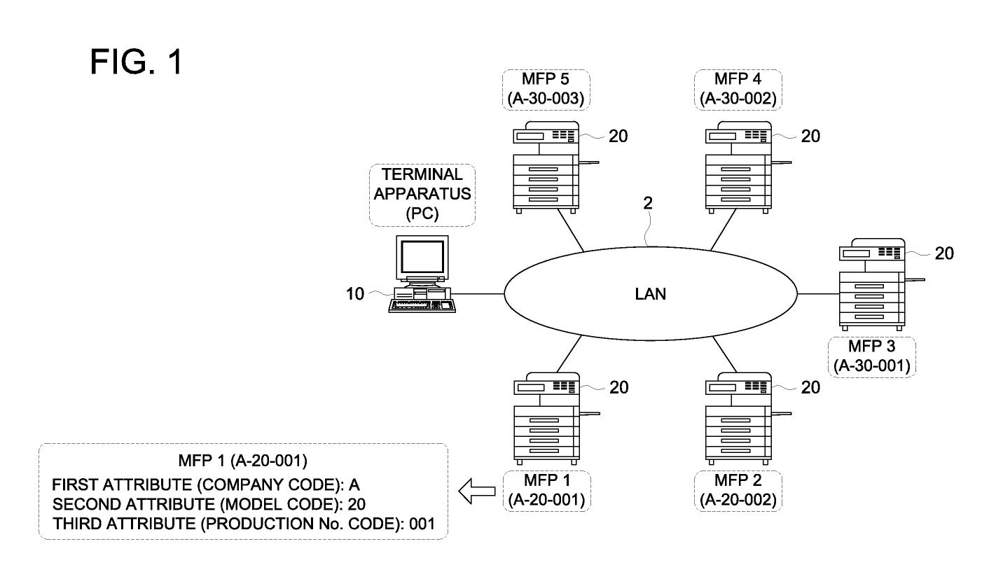

FIG. 1 is a drawing illustrating a configuration of a system relating to the first embodiment of the present invention where terminal apparatus 10 and a MFP 20 (Multi Function Peripheral) are connected with network 2 such as LAN (Local Area Network).

Terminal apparatus 10 is an information processing apparatus that accesses to MFP 20 through network 2 and executes instructions of various works and requests of operations such as a document printing. For example, terminal apparatus 10 is configured with a personal computer (PC) installed with a printer driver program.

This terminal apparatus 10 is provided with functions of print data generation apparatus to generate print data which causes an image indicated to be printed and an erasable mark (a first mark) printed by using a color erasable toner whose color is erasable by irradiation of a specific wavelength light to be printed on a same recording sheet, and further causes to print on the recording sheet an un-erasable mark (a second mark) printed by using a normal toner (color un-erasable toner) whose color is not erasable by irradiation of said specific wavelength light.

The print data generated by terminal apparatus 10 include data formed with PDL (Page description Language) and data of raster image. In cases where MFP 20 is compliant with the PDL, terminal apparatus 10 generates data (print data) formed by the PDL by use of the printer driver of MFP 20. While, in cases where MFP 20 is not compliant with the PDL, terminal apparatus 10 generates data (print data) formed with the raster image data by use of the printer driver of MFP 20. The PDL data include data composed of a vector image and control command, or data composed of a vector image, raster image and control command.

An area to be printed with the normal toner and an area to be printed with color erasable toner are, for example, described in the print data as information (toner specifying information) specifying types of toners to be used for each of areas. In the case of data being formed with the PDL, the area is described on the vector image, and in the case of image data, described on the pixel. Description on a pixel is conducted by including the information indicating which of the normal toner or the color erasable toner is used for the printing.

In the present embodiment, the case is exemplified where MFP 20 is compliant with the PDL and terminal apparatus 10 generates the data formed with the PDL.

MFP 20 is a multifunctional image processing apparatus (Multi Function Peripheral or Multi Function Printer; MFP) which is provided with a copying function to readout an image of an original document and output a recording sheet by printing a duplicate image of the original document image, a scanning function to readout the image data (raster image data) of the original document, and store the image data in a file and transmits to terminal apparatus 10 or a server; a printer function to print an image relating to the received image data from the terminal apparatus 10 or an image relating to the image data stored in said MFP 20, on the recording sheet and output; and a facsimile function to transmit and receive the image data.

Further, MFP 20 is provided with a function as an image data generation function to generate image data when an image of readout original document and an erasable mark (a first mark) being printed by use of the color erasable toner are printed on a same recording sheet, or to generate image data where an un-erasable mark (a second mark) being printed by use of the normal color is further printed on the same recording sheet; and a function as a printing apparatus to print on the same recording sheet an image (image of the original document or an image indicated to print) and an erasable mark using the color erasable toner, and further to print on the same recording sheet a un-erasable mark being printed by use of the normal color, based on the image data generated by the data generating function or received from terminal apparatus 10. The image data generation function of MFP 20 is substantially the same as the print data generation function of terminal apparatus 10. The above describe image data generated by said generation function of MFP 20 is substantially the same as the above described print data generated by the function of terminal apparatus 10. Meanwhile, the un-erasable mark will be described in and after the second embodiment.

In the present embodiment, a plurality of MFP 20 (MFP1-MFP 5, in the illustrated example) is connected to network 2. A network identifier (host name) of each MFP 20 is configured with a first attribute indicating a company code, a second attribute indicating a model code and a third attribute indicating production number code.

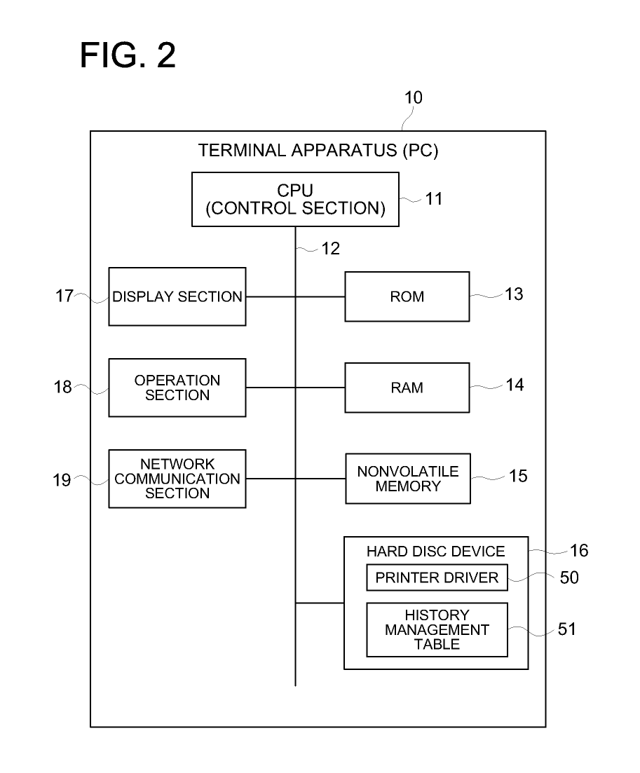

FIG. 2 is a block diagram illustrating an outline structure of terminal apparatus 10. Terminal apparatus 10 is configured by connecting via bus 12 to CPU (Central Processing Unit) 11 as the control section with ROM (Read Only Memory) 13, RAM (Random Access Memory) 14, nonvolatile memory 15, hard disk device 16, display section 17, and network communication section.

CPU 11 controls the activities of terminal apparatus 10 based on program stored in ROM 13. Ram 14 is utilized as a work memory to temporarily store various data while CPU 11 executes a program. Nonvolatile memory 15, which being a memory to keep memories even while a power source is turned off, memorizes information inherent to the apparatus and various setting information. Hard disk 16 stores various storage data, electronic data of document, printer driver 50 of MFP 20, a history control table 51 for memory controlling the information relating to a print history of document. Printer driver 50 contains electronic data of an erasable mark and an un-erasable mark to be added on the image of document.

Display section 17 is configured of a display unit such as a LCD (Liquid Crystal Display), and displays various images and images of documents, and the like. Operation section 18 is configured of a key board, a mouse and the like, and receives operations and inputs executed to terminal apparatus 10 by a user. Network communication section 19 communicates with MFP 20 via network 2.

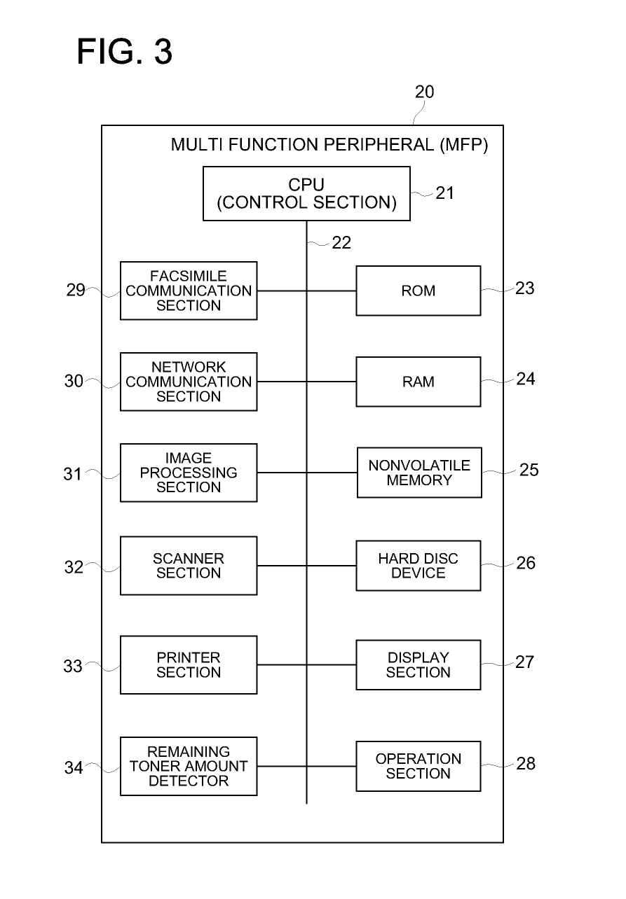

FIG. 3 is a block diagram illustrating an outline structure of the MFP 20. MEP 20 is configured by connecting, via bus 22 to CPU 21 as the control section, with ROM 23, RAM 24, nonvolatile memory 25, hard disc device 26, display section 27, operation section 28, facsimile communication section 29, network communication section 30, image processing section 31, scanner section 32, printer section 33, and remaining toner amount detector 34.

CPU 21 controls the activities of MFP 20 based on the program stored in ROM 23. RAM 24 is utilized as a work memory to temporarily store various data in cases when CPU 21 executes the program, and is utilized as an image memory to temporarily store the image data, as well.

Nonvolatile memory 25, which being a memory to keep memories even while a power source is turned off, memorizes information inherent to the apparatus and various setting information. Hard disk device 26 stores various storage data and stores the inputted image data as well. In nonvolatile memory 25 or hard disk device 26, electronic data of an erasable mark and a un-erasable mark to be added on the readout image of document are stored.

Display section 27 is configured of a liquid crystal display and the like, and displays various screens such as an operation screen, a setting screen, a confirmation screen, a notification screen. Operation section 28 is configured of various buttons such as a start button, a stop button, a numeral key pad and the like, and a touch panel provided on the surface of a liquid crystal display to detect the position of pushed coordinates, and receives various operations executed by a user to MFP 20.

Facsimile communication section 29 transmits and receives image data with an external apparatus equipped with a facsimile function via a public line. Network communication section 30 communicates with terminal apparatus 10, a server and the like via network 2.

Image processing section 31 executes a rasterizing processing on print data received from terminal apparatus 10 (data formed with a page description language), and executes various image processing such as image correction, rotation, enlargement/reduction, compression/extension on the image data.

Scanner section 32 acquires image data by optically reading an original document. Configuration of scanner section 32 will be described below.

Printer section 33 forms and outputs an image on a recording sheet based on image data with an electrophotographic process. Printer section 33 is, for example, configured of a laser printer provided with a conveying device of the recording sheet, a photosensitive drum, a charging unit, a LD (Laser Diode) being controlled lighting based on the inputted image data, a scanning unit to scan the emitted laser beam from the LD on the photosensitive drum, a developing unit, a transfer and separation unit, a cleaning unit and a fixing unit. An LED printer which irradiates with an LED (Light Emitting Diode) instead of laser beam and other type of printer may be also utilized.

Further, printer section 33 has a function of forming color images on the recording sheet by selectively using color erasable toners (C: cyan, M: magenta, y: yellow, and K: black) whose color is erasable (become colorless) by exposing to a specific wavelength light and normal toners (C, M, Y, K). Printer section 33 is separately provide with the above described units of a photosensitive drum, a charging unit, an LD (or LED), a scanning unit, a developing unit, a transfer and separation unit, a cleaning unit and the like for the normal toners and for the color erasable toners, and is capable of forming images with selectively using both type of toners by unit of a recording sheet (unit of a print surface), or with using both type of toners in a single recording sheet (in a single print surface).

Color erasable toner is for example a toner which becomes colorless by irradiation of near infrared light. For example the color erasable toner includes cyanine series dye as a coloring agent and organic ammonium borate as a decolorizing aid and by the irradiation of near infrared light the dye becomes a colorless leuco compound.

Remaining toner amount detector 34 separately detects the remaining toner amount of normal toner and the remaining toner amount of color erasable toner.

Scanner section 32 of MFP 20 is configured of a reading light source to irradiate the exposure light onto an original document for reading-out the original document, an erasing light source to irradiate the specific wavelength light (near infrared light) onto the original document for decolorizing the color erasable toner, a reading section to read out the original document by receiving reflection light from the original document irradiated with the exposure light of the reading light source, and the like. Scanner section 32 is provided with a function to erase the image (color erasable image) in the original document printed with the color erasable toner by the irradiation of specific wavelength light onto the original document, in addition to the function to read out the original document.

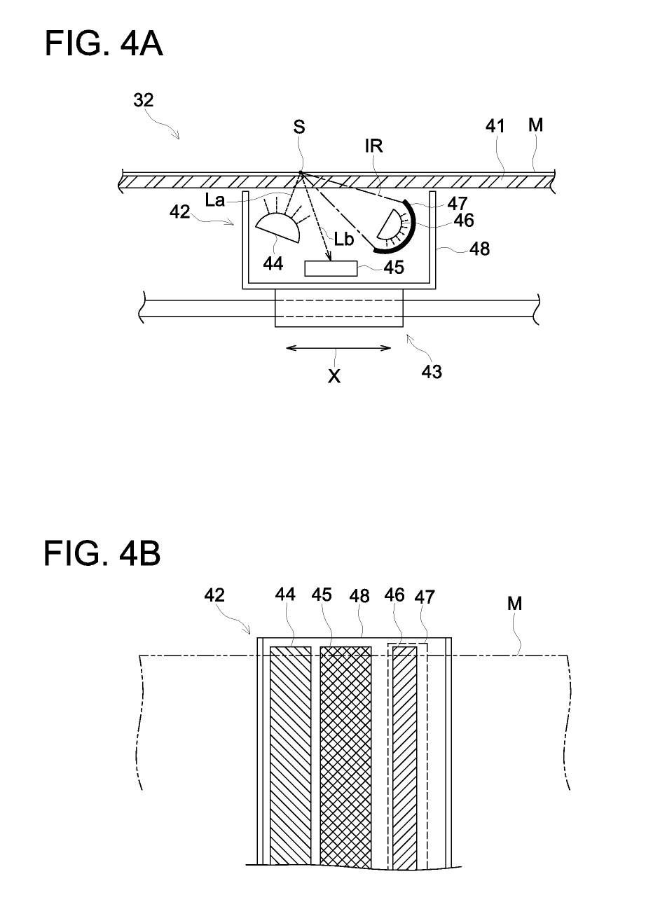

FIGS. 4A and 4B illustrate an outline structure of the scanner section. Scanner section 32 relating to the present embodiment is configured as a flat bed type (fixed original document type) scanner. As shown in FIG. 4A, scanner section 32 is provided with platen glass 41 (original document table) on which original document M is placed, reading unit 42 to read out original document M on platen glass 41, and moving mechanism 43 to move reading unit 42 in longitudinal direction of original document M (reading direction X).

Reading unit 42 is configured of reading light source 44 to irradiate exposure light La onto original document on platen glass 41, line image sensor (photoelectric conversion element) 45 as the reading section for reading out a single line part of original document M in width direction by receiving reflection light Lb from original document M, erasing light source 46 for irradiating specific wavelength light IR onto original document M, a reflection plate 47 to condense specific wavelength light IR from erasing light source 46 and irradiate onto reading out area (reading position) S of original document M by line image sensor 45, to moving mechanism 43. FIG. 4B is a plan view of reading unit 42 seen from upper side.

A prescribed size of reading out area S by line image sensor 45 is line-shaped (single dimension) area. Exposure light La from reading light source 44 and specific wavelength light IR from erasing light source 46 are irradiated toward reading out area S of original document M by line image sensor 45. Line image sensor 45 sequentially moves in the longitudinal direction of original document M by moving mechanism 43, and reads out original document M at line shaped reading out area S by each line (scan reading). Further, scanner section 32 is provided with a conversion section to convert the analogue image signals outputted from line image sensor 45 to digital image data.

Scanner section 32 relating to the present embodiment is configured to be capable of irradiating exposure light La and specific wavelength light IR onto reading out area S of line image sensor 45 even without moving reading unit 42, namely capable of irradiating both light on a same line (same scanning line of original document on platen glass 41. In cases where specific wavelength light IR is irradiated to original document M on platen glass 41, if the image of original document M is printed with the color erasable toner the irradiation area of specific wavelength light is made colorless, and if the image of original document M is printed with the normal toner the area is not made colorless. In cases when images with both toners are mixed, only the image area printed with the color erasable toner become colorless.

Generally, the color erasable toner varies in color erasing time (color erasing rate) according to irradiation intensity (light amount) of the specific wavelength light. In the present embodiment, in order to condense specific wavelength light 1R diffused from erasing light source 46 onto reading out area S of line image sensor 45, and to increase the amount of light to shorten the erasing time, reflection plate 47 having the condenser function is provided.

Next, activities of terminal apparatus 10 and MFP 20 will be explained.

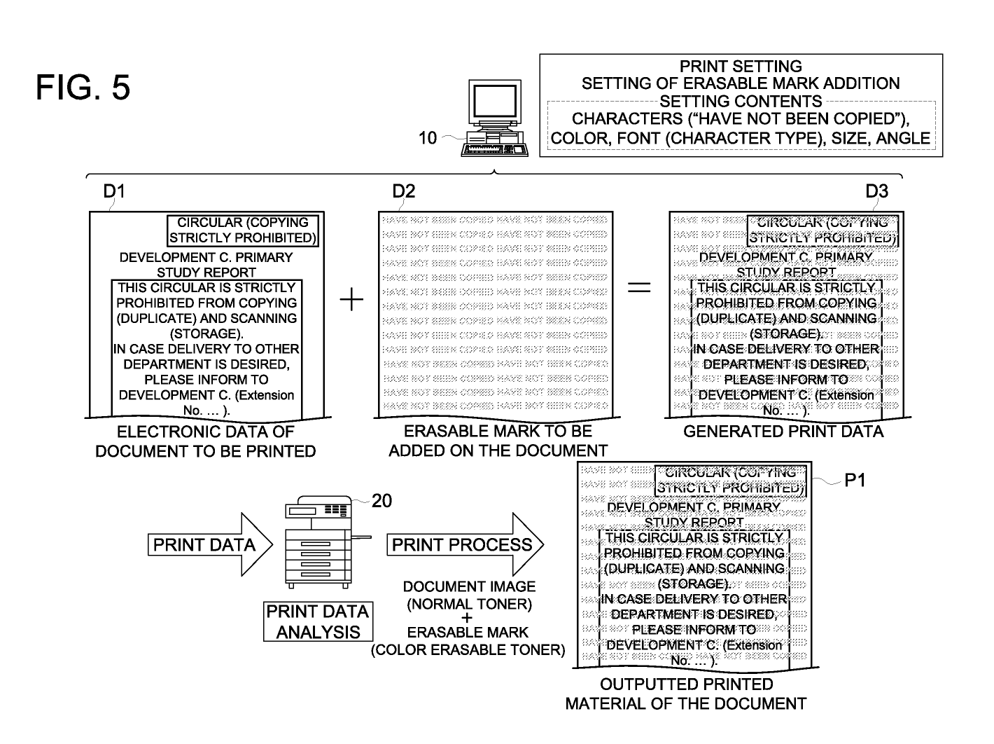

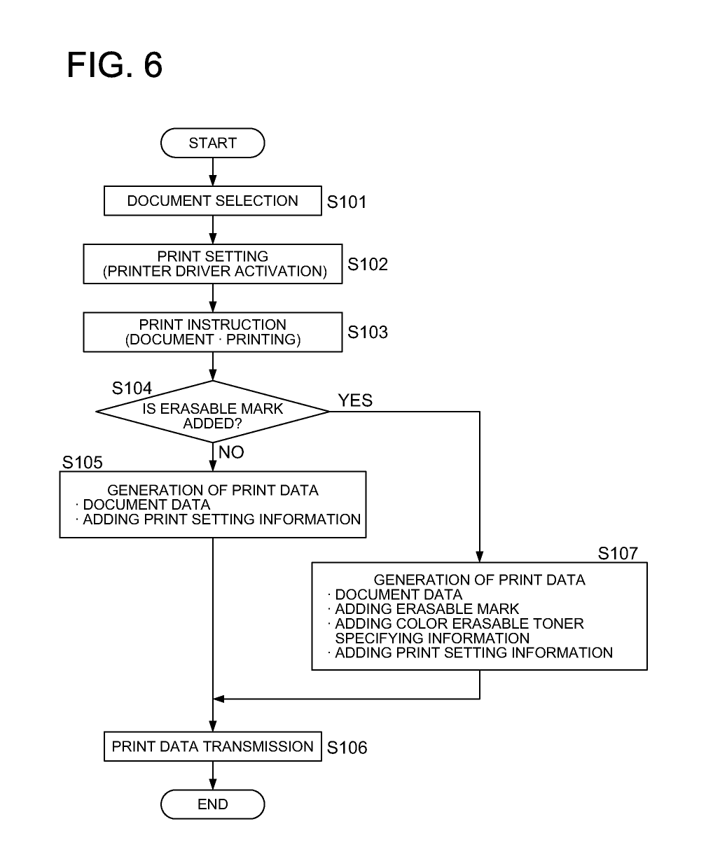

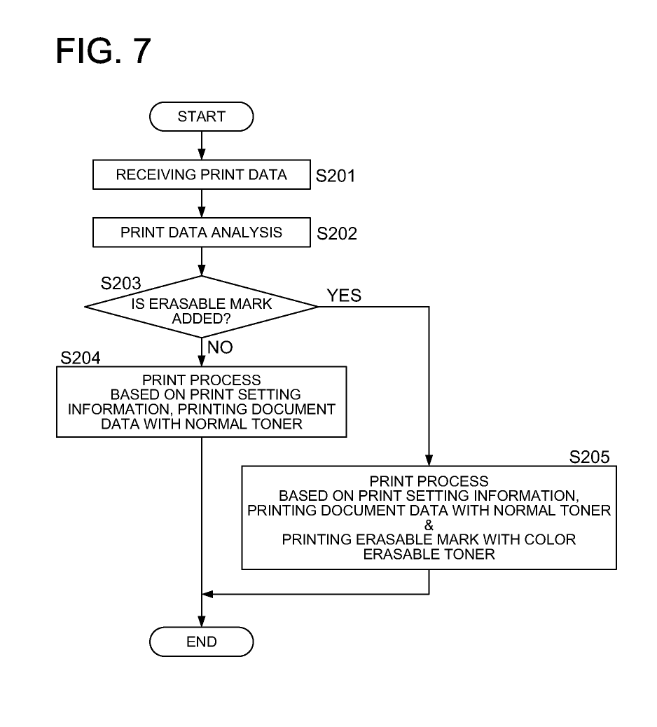

FIG. 5 is a flow diagram illustrating the flow while printing of a document added with an erasable mark is requested from terminal apparatus 10, and MFP 20 outputs the printed material. FIG. 6 is a flow diagram illustrating operations by terminal apparatus 10 for requesting the printing of document. FIG. 7 is a flow diagram illustrating printing operations of the document by MFP 20 having received the request.

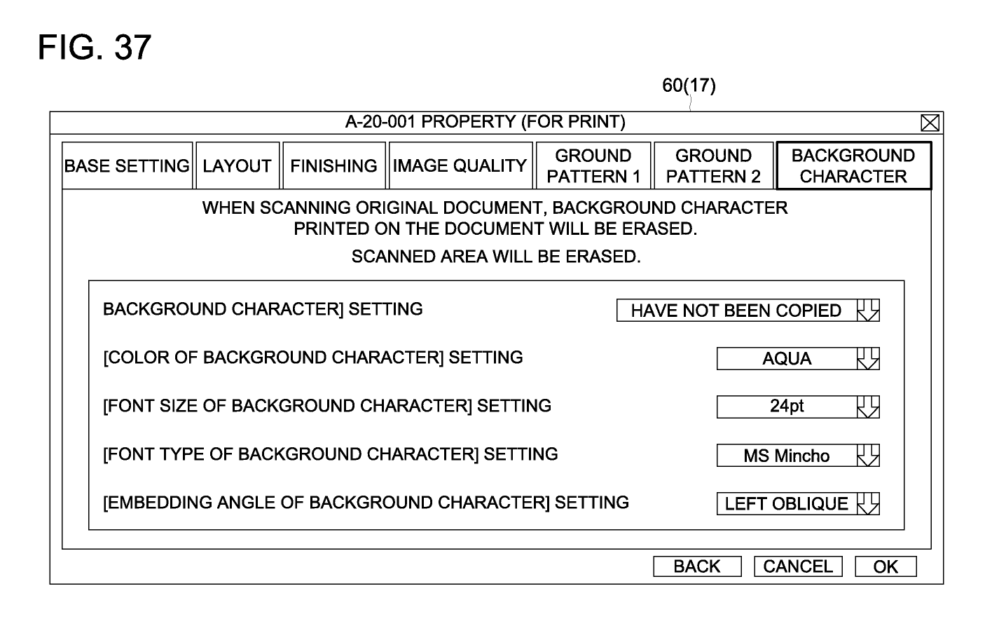

As shown in FIG. 6, terminal apparatus 10 receives a selection of document to be printed from a user via display section 17 and operation section 18 (step S101: D1 in FIG. 5), and receives a print setting via printer driver 50 (step S102). In the print setting, the user sets whether to add on the printed material the erasable mark to be printed by use of color erasable toner or not (see FIG. 5 and FIG. 37).

The erasable mark is background characters configured with characters such as “HAVE NOT BEEN COPIED” to be added on the background of the document. The configuration may be that a type of mark to be added is selectable, for example, among “HAVE NOT BEEN COPIED”, “NOT COPIED” and the like.

Further in the setting regarding the erasable mark, color, font (character style), size, and angle (arranging angle) of the characters can be set. Regarding the color, the configuration may be that the color is selectable among plural types of previously prepared low density colors such as gray and water color. In the example in FIG. 5 the erasable mark to be added by the above setting is shown by characters of “HAVE NOT BEEN COPIED” with a color of low color density, as illustrated by D2.

When receiving a print instruction from the user (step 103), in a case where the erasable mark is not added (step S104: No), terminal apparatus 10 generates print data including electronic data of the document (document data) and print setting information (step S105), and sends to MEP 20 (step S106/End). In a case where the erasable mark is added (step S104: Yes), terminal apparatus 10 generates print data (D3 in FIG. 5) including electronic data of the document (document data) which being a document image (D1 in FIG. 5) added with the erasable mark (D2 in FIG. 5), color erasable toner specifying information that specifies to use the color erasable toner for the printing of added erasable mark, and print setting information (step S107), and sends to MEP 20 (step S106/End).

As shown in FIG. 7, when receiving the print data from terminal apparatus 10 (step S201), MFP 20 analyzes whether the erasable mark is added on the image of document included in the print data or not (step S202). In a case where the erasable mark is not added (step S203; No), according to the print setting information included in the print data, printer section 33 prints the image based on the document data on a recording sheet by using the normal toner, and outputs (step S204 (print process)/End).

In a case when the erasable mark is added (step S203; Yes), according to the print setting information included in the print data, printer section 33 prints the image based on the document data on a recording sheet by using the normal toner, and printer section 33 prints the erasable mark superimposing on the recording sheet by using the color erasable toner (step S205: print process/End). In this printing process, the order of printing with the normal toner and with the color erasable toner needs not be restricted.

As illustrated by an example in FIG. 5, on a printed material P1 of the document added with the erasable mark by MFP 20, the characters of “HAVE NOT BEEN COPIED” (background character) are repeatedly printed in all sheet surface. This erasable mark is printed with the color of low color density using the color erasable toner.

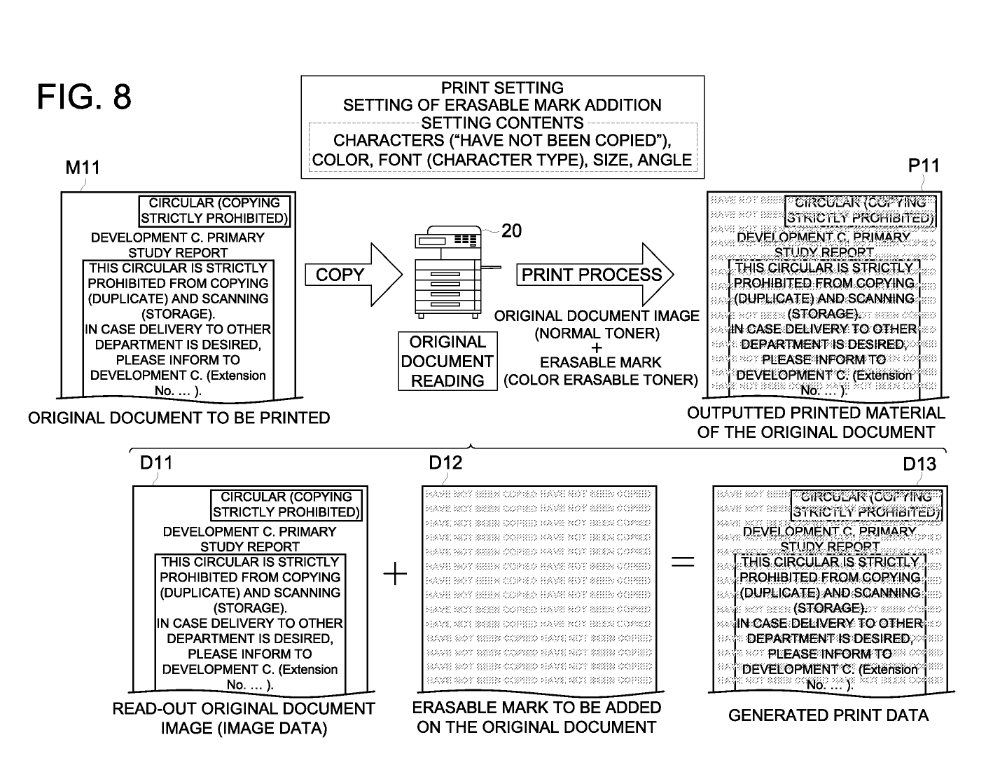

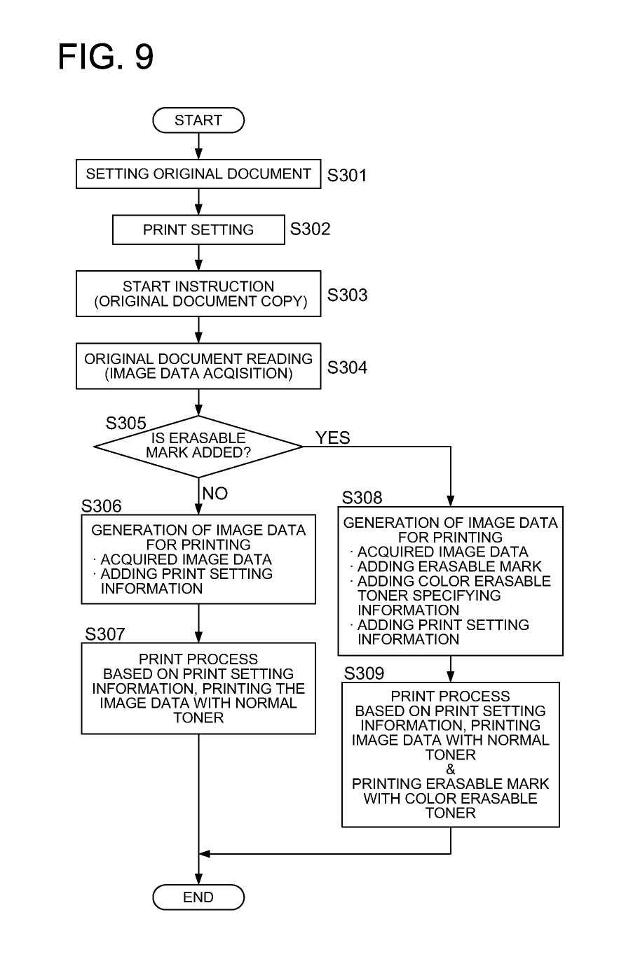

FIG. 8 is a diagram illustrating a flow of copying the original document by MFP 20 for outputting a printed material added with an erasable mark. FIG. 9 is a flow diagram illustrating operations of copying the original document by MFP 20 for outputting a printed material added with an erasable mark.

As shown in FIG. 9, a user sets an original document at scanner section of MFP 20 (step S301), and MFP 20 accepts the print setting of the original document to be printed via display section 27 and operation section 28. In the print setting, the user set whether to add the erasable mark on the printed material of the original document or not.

Similarly to the case of terminal apparatus 10, the erasable mark is back ground characters to be added on the background of copied image of original document which being configured of characters such as “HAVE NOT BEEN COPIED”. The configuration may be that a type of mark to be added is selectable, for example, among “HAVE NOT BEEN COPIED”, “NOT COPIED” and the like. Further in the setting regarding the erasable mark, color, font (character style), size, and angle (arranging angle) of the characters can be set. Regarding the color, the configuration may be that the color is selectable among plural types of previously prepared low density colors such as gray and water color. In the example in FIG. 8 the erasable mark to be added by the above setting is shown by characters of “HAVE NOT BEEN COPIED” with a color of low color density, as illustrated by D12.

When receiving a print instruction from the user (step 303), MFP 20 reads out the image or original document with scanner section 32 to obtain the image data (step S304). In a case where the erasable mark is not added (step S305: No), CPU 21 generates image data for printing including the obtained image data and print setting information and sends to printer section 33 (step S306). Printer section 33 prints on the recording sheets and outputs the image based on the image data according to the print setting information by using the normal toner (step S307: print process/End).

In a case when adding of erasable mark is set (step S305: Yes), CPU 21 generates the image data for printing (D13 in FIG. 8) including the image data which being the obtained document image (D11 in FIG. 8) added with the erasable mark (D12 in FIG. 8), color erasable toner specifying information that specifies to use the color erasable toner for the printing of the added erasable mark, and print setting information, and sends to printer section 33 (step S308). Printer section 33 prints on the recording sheets and outputs the image based on the image data according to the print setting information by using the normal toner, and prints and outputs the erasable mark superimposing on the recording sheet by using the color erasable toner (step S309 (print process)/End). In this printing process, the order of printing with the normal toner and with the color erasable toner needs not be restricted.

As illustrated by an example in FIG. 8, on a printed material P11 copied of the original document M11 added with the erasable mark by MFP 20, the characters of “HAVE NOT BEEN COPIED” (background character) are repeatedly printed in all sheet surface. This erasable mark is printed with the color of low color density using the color erasable toner.

The above function of adding an erasable mark on a printed material in the copying of original document by MFP 20 is preferably set to be usable only by users having high level of authority.

Regarding the generation of print data (image data for printing) described at step 107 of FIG. 6 and step 308 of FIG. 9, for example, the print data may be separately generated between the area to be printed by use of the normal toner and the area to be printed by use of the color erasable toner. Details of two examples will be described below.

1. A case when an image to be printed and an erasable mark are simply superimposed:
Importing data relating to the document indicated to be printed (or the original document image readout by scanner 32 indicated to readout the original document).
Generating a first print data for printing an image based on the imported data by use of the normal toner.
Generating a second print data for printing an erasable mark by use of the color erasable toner.
Generating a print data including the first print data, the second print data, and information indicating to print these data on the same recording sheet
Sending the generated print data to MFP 20 (or printer section 33).

In the present case, it is preferable to print the image by normal toner upon printing the erasable mark by color erasable toner.

2. A case when an image to be printed is made a front image and an erasable mark is made a background image:
Importing data relating to the document indicated to be printed (or the original document image readout by scanner 32 indicated to readout the original document).
Generating a first print data for printing an image based on the imported data by use of the normal toner.
Generating a composite image configured with the above image as the front image and an erasable mark as the background image, cutting out a part of the erasable mark which is not hidden by the above image (front image) out of the erasable mark, and generating a second print data for printing the cutout part by use of the color erasable toner.
Generating a print data including the first print data, the second print data, and information indicating to print these data on the same recording sheet
Sending the generated print data to MFP 20 (or printer section 33).

In this case, the order of printing with the normal toner and with the color erasable toner needs not be restricted.

The print data (electronic data) of erasable mark are previously memorized. In cases when color, font, size and the like of the erasable mark are changed by a print setting, the corresponding attribute values of the print data are changed. Further, a program to create print data of the erasable mark according to the specified type erasable mark and the attribute values may be provided, and the print data of erasable mark may be created by the program.

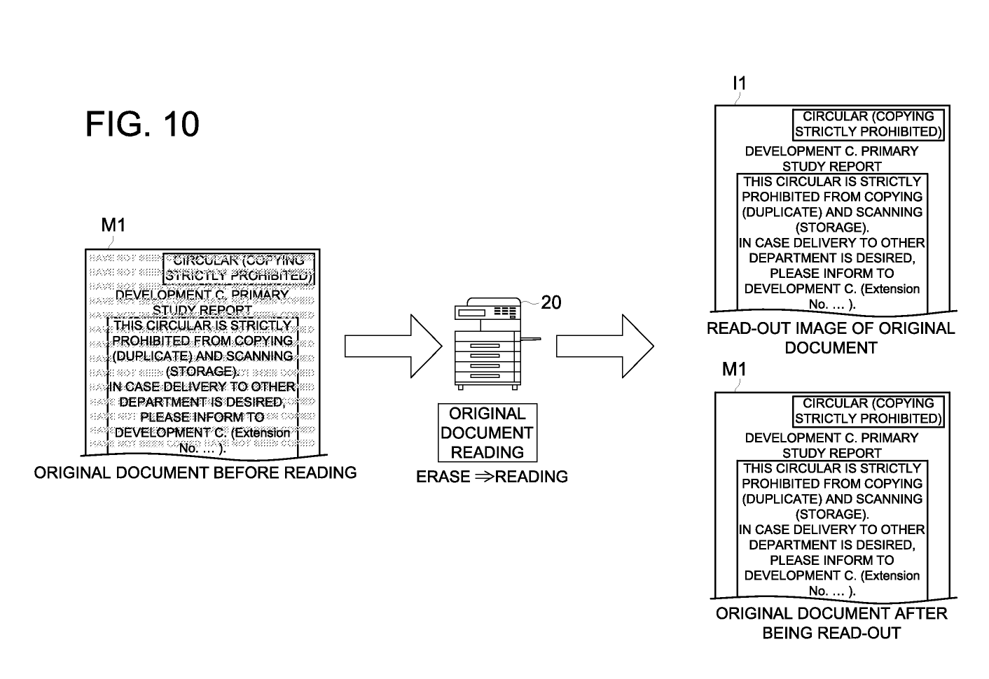

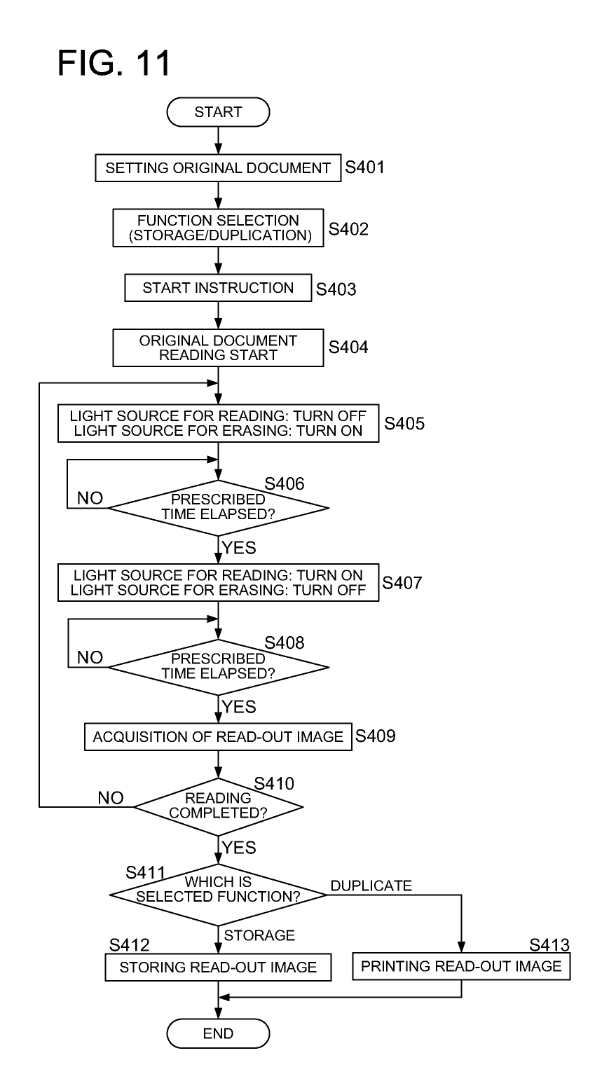

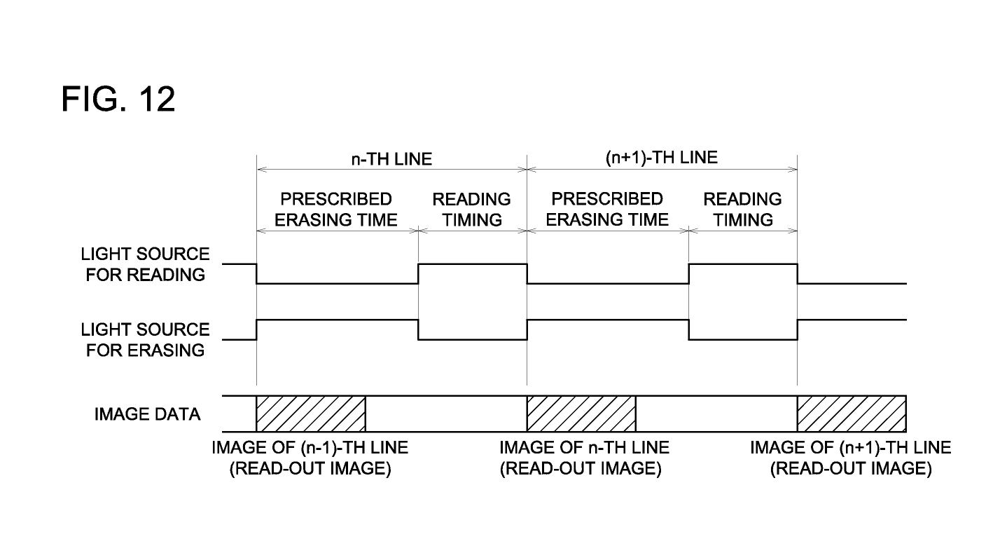

FIG. 10 is a diagram illustrating original document M1 added with the erasable mark, a readout image I1 acquired when this original document M1 being read by MFP 20, and original document M1 after having been read. The original document before reading in this figure is printed material P1 shown in FIG. 5 or printed material P11 shown in FIG. 8. FIG. 11 is a flow diagram illustrating reading operations of the original document by MFP 20. FIG. 12 is a timing chart illustrating put-on/put-off timing of a light source and reading timing of the original document in the original document reading operation.

As shown in FIG. 11, an original document is set by a user at scanner section 32 of MFP 20 (step S401), and MFP 20 receives a function selection of reading/storage or duplication (copying function) of the original document via display section 27 and operation section 28 (step S402). When receiving a start instruction (step S403), MFP 20 starts the reading of original document with scanner section 32 (step S404).

When the original reading by scanner section 32 is started, CPU 21 of MFP 20 turns on only a light source for erasing 46 out of light source for reading 44 and light source for erasing both having been turned off before the start of reading (step 405-step 406; No). After lightening the light source for erasing during a required period for making the color erasable toner colorless (step S406; Yes/prescribed erasing time in FIG. 12), CPU 21 turns off light source for erasing 46 and turns on light source for reading 44 (step 407-step 408; No). Line image sensor 45 (refer to FIG. 4) receives and accumulates reflection light Lb from reading area S of the original document where exposure light is irradiated by light source for reading 44, and reads out the image (line image) at reading area S.

CPU 21 turns on light source for reading 44 during the required period for line image sensor 45 to read out the image by light accumulation (step S408; Yes/reading timing in FIG. 12), and acquires the image data for 1 line outputted from scanner section 32 to temporarily store in RAM 24. Until finishing the original document reading (image data acquisition for all lines) step S 405-step S 409 are repeated (step S410; No), and when the original document reading is finished (step S410; Yes), CPU 21 stores the temporarily stored readout image of the original document (image data) into hard disk device 26 (step S412/End) in cases when the function of storage is selected (step 411; storage). In cases when the function of duplication is selected (step 411; duplicate), printer section 33 prints and outputs the image based on the readout image of original document (image data) temporarily stored in RAM 24 on the recording sheet by use of the normal toner (step 413/End).

As shown in FIG. 10, when MFP 20 reads out original document M1 added with the erasable mark, readout image 11 without erasable mark is acquired. In the case of storage, this readout image 11 is stored in hard disk device 26, and in the case of duplication the printed material printed with (duplicated) this readout image 11 is outputted. Further, the original document M1 after having been read becomes to the state that the erasable mark is erased, which is changed from the state before reading. In original document M1, the fact that the erasable mark is missing becomes a trace (evidence) of image reading having been executed.

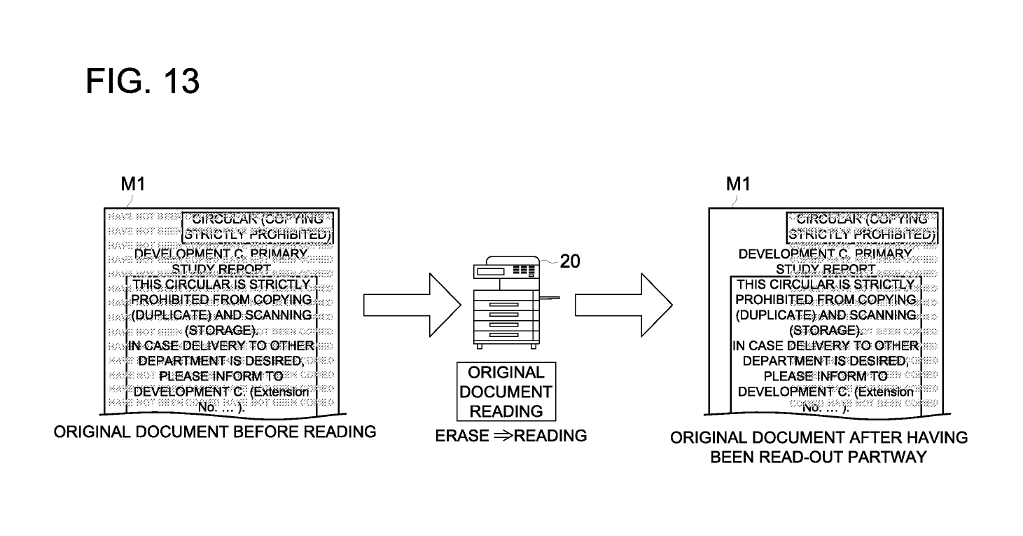

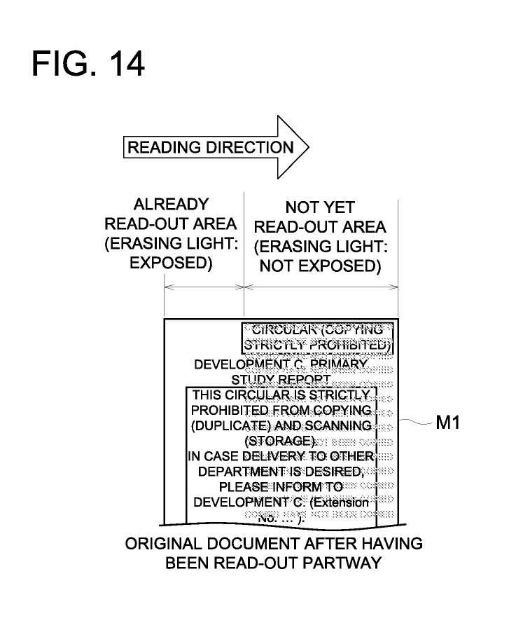

FIG. 13 is a diagram illustrating original document M1 added with an erasable mark, and original document M1 after having been read in the case where this original document M1 was read halfway by MFP 20. FIG. 14 is a diagram illustrating in detail original document M1 having been read in FIG. 13. As shown in FIG. 13 and FIG. 14, in the case when original document M1 added with the erasable mark is read half way by scanner section 32 of MFP 20, the erasable mark in already readout area is erased on original document M1 after having been readout, and the erasable mark in not-yet-readout area is remained.

In this way, when receiving the setting for adding an erasable mark on a printed material of the document which is required of printing by MFP 20, terminal apparatus 10 relating to the present embodiment adds the erasable mark on an image of the document, generates a print data in which use of color erasable toner is specified for the printing of erasable mark, and sends the print data to MFP 20. Based on the print data, MFP 20 prints the erasable mark by using the color erasable toner on the printed material.

Further, when receiving the setting for adding an erasable mark on a printed material of the document in a process of copying an original document, MFP 20 relating to the present embodiment adds the erasable mark on a readout image of the document, generates a print data (image data for printing) in which use of color erasable toner is specified for the printing of erasable mark, and prints the erasable mark by using the color erasable toner on the printed material (copied material of the original document).

In cases where the above described printed material added with the erasable mark is used as an original document and a specific wavelength light is irradiated at the time of reading the original document by scanner section 32 of MFP 20, the erasable mark is erased from the original document. Accordingly, the fact that image reading has been executed is distinguished by the printed material of the original document itself, thus, duplication operation can be restrained in the case when duplication through image reading of a printed material is prohibited. For example, in cases of circulating confidential document strictly prohibited from duplication in an office, it is possible to distinguish from the document itself by existence or nonexistence of the erasable mark that the document has not been copied, or the document has been illegally copied.

Further, in cases where there are erased area and remaining area of the erasable mark, it can be determined that the erased area of the original document has been copied. In this way even in the case when a partial area has been copied, the copied part can be distinguished from the document itself.

Further, in cases where by explicitly showing the state of not-having-been-copied by characters such as “HAVE NOT BEEN COPIED”, and erasable marks that may cause presage (cautionary sense) of something happening in case of executing a copy are arranged in multiple numbers on all area of a sheet of printed material to be extinguishable by viewing, a sense of caution can be caused against copying or scanning of the printed material, and the restraining effect to these activities can be heightened.

In order to reduce toner consumption, the erasable mark to be printed by use of the color erasable toner may be added in smaller area or in small number on the printed material other than adding in multiple numbers on all area of a sheet of printed material. For example, in an arbitrary position (specified position) or in marginal part (upper marginal part, bottom marginal part, or side marginal part), one or plurality of marks may be added. Further, the erasable mark may be added by superimposing on the image of the printed material, or may be added without superimposing at an empty area of the image or marginal area of the sheet.

### Second Embodiment

As described in the first embodiment, in the printed material printed with the erasable mark by use of the color erasable toner, only the erasable mark is erased in the case when the specific wavelength light is irradiated at the time of image reading by MFP 20. In this case, a person other than the person who executed the image reading of the printed material, for example a third person who views the printed material after having been erased of the erasable mark and the like is difficult to determine whether the erasable mark has been previously printed or not from the printed material itself. As an example to make this determination easy, in the second embodiment, the case will be described when information indicating the fact that an erasable mark is added (display information) is printed by using the normal toner as an un-erasable mark at the time of printing the erasable mark.

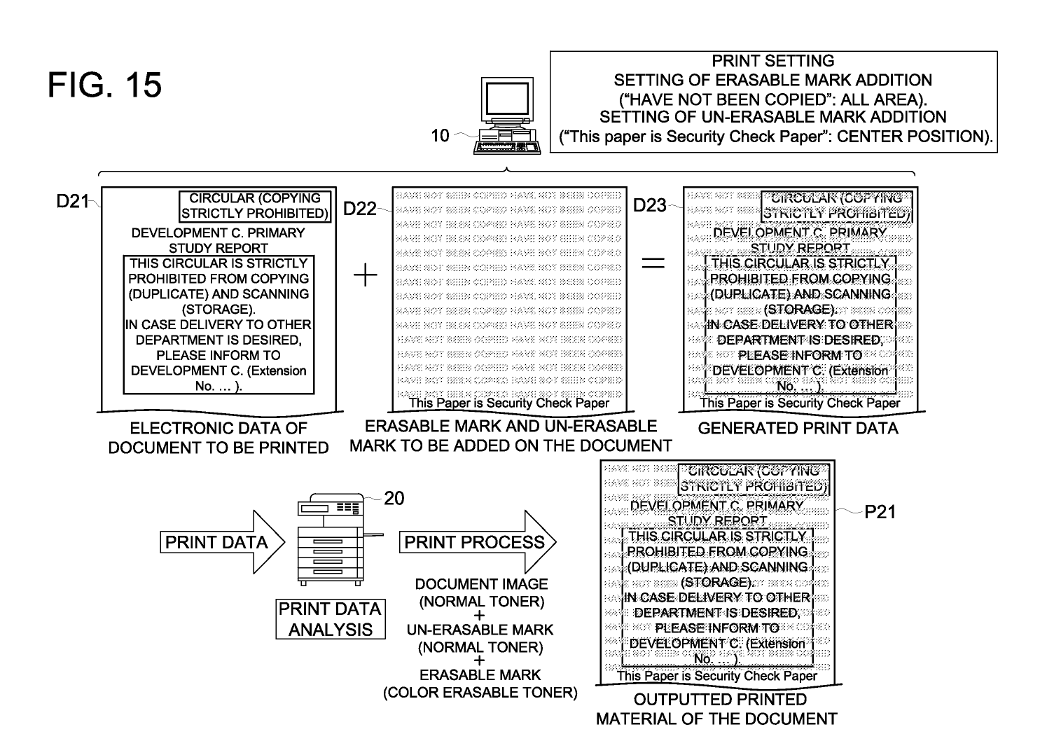

FIG. 15 is a diagram illustrating a flow where the printing of document added with an erasable mark and an un-erasable mark is requested from terminal apparatus 10, and MFP 20 outputs the printed material. In the present embodiment, the un-erasable mark has a function of indicating the fact of the erasable mark having been printed on the printed material (recording sheet), and in addition, has a function of indicating that said printed material is a printed material of security protection subject (security check paper).

The un-erasable mark having these two functions is configured of, for example, characters (character information) such as “This Paper is Security Check Paper”. Regarding adding of the un-erasable mark, either of the configuration where the setting of un-erasable mark being automatically added is conducted when adding of the erasable mark is set in the print setting, or the configuration when a user can manually set whether to add or not to add the un-erasable mark may be possible. Regarding the type of un-erasable mark, the configuration of selecting from previously prepared plural types is possible. Further in the setting regarding the un-erasable mark, color, font (character style), size, adding position, print surface (front/back) of the characters can be configured to be set.

In FIG. 15, the case is illustrated where in the print setting of document D21 at terminal apparatus 10, the setting of adding the erasable mark “HAVE NOT BEEN COPIED” is executed, and the un-erasable mark “This Paper is Security Paper” is added at a central position of the document image (D22). After terminal apparatus 10 generates and sends this print data (D23) to MFP 20, MFP 20 prints the image (document image and un-erasable mark arranged at the center of document image) based the document data in which the un-erasable mark is added at the center by using the normal toner on the recording sheet, prints and outputs by superimposing the erasable mark by using the color erasable toner on said recording sheet (P21). In this printing process, order of printing by the normal toner and by the color erasable toner is not restricted.

Although illustration is omitted, similarly in the copying of original document by MFP 20, in print setting at MFP 20 the erasable mark and the un-erasable mark can be added on the copied material (printed material).

Similarly to the generation of print data explained in the first embodiment, generation of print data relating to the present embodiment may be for example separately generated between the area to be printed by use of the normal toner and the area to be printed by use of the color erasable toner. Details of two examples will be described below.

1. A case when an image to be printed and an erasable/un-erasable marks are simply superimposed:
Importing data relating to the document indicated to be printed (or the original document image readout by scanner 32 indicated to readout the original document).
Generating a first print data for printing an image based on the imported data by use of the normal toner.
Generating a second print data for printing an un-erasable mark by use of the normal toner.
Generating a third print data for printing an erasable mark by use of the color erasable toner.
Generating a print data including the first print data, the second print data, the third print data, and information (setting information) indicating to print these data on the same recording sheet
Sending the generated print data to MFP 20 (or printer section 33).

In the present case, it is preferable to print the image and un-erasable mark by normal toner, after printing the erasable mark by color erasable toner.

2. A case when an image to be printed is made a front image and an erasable/un-erasable mark is made a background image:
Importing data relating to the document indicated to be printed (or the original document image readout by scanner 32 indicated to readout the original document).
Generating a first composite image configured with an image based on the imported data as a front image, and an un-erasable mark as a background image.
Generating a first print data for printing the first composite image by use of the normal toner.
Generating a second composite image configured with the first composite image as a front image, and an erasable mark as a background image, cutting out a part of the erasable mark which is not hidden by the first composite image, and generating a second print data for printing the cutout part by use of the color erasable toner.
Generating a print data including the first print data, the second print data, and information indicating to print these data on the same recording sheet
Sending the generated print data to MFP 20 (or printer section 33).

In this case, the order of printing of the un-erasable mark and the image (first composite image) with the normal toner and printing of the erasable mark (cutout part) with the color erasable toner needs not be restricted.

The print data (electronic data) of erasable mark and un-erasable mark are previously memorized. In cases when color, font, size and the like of the erasable/un-erasable marks are changed by a print setting, the corresponding attribute values of the print data are changed. Further, a program to create print data of the erasable/un-erasable marks according to the specified type and attribute values of the marks may be provided, and the print data of the marks may be created by the program.

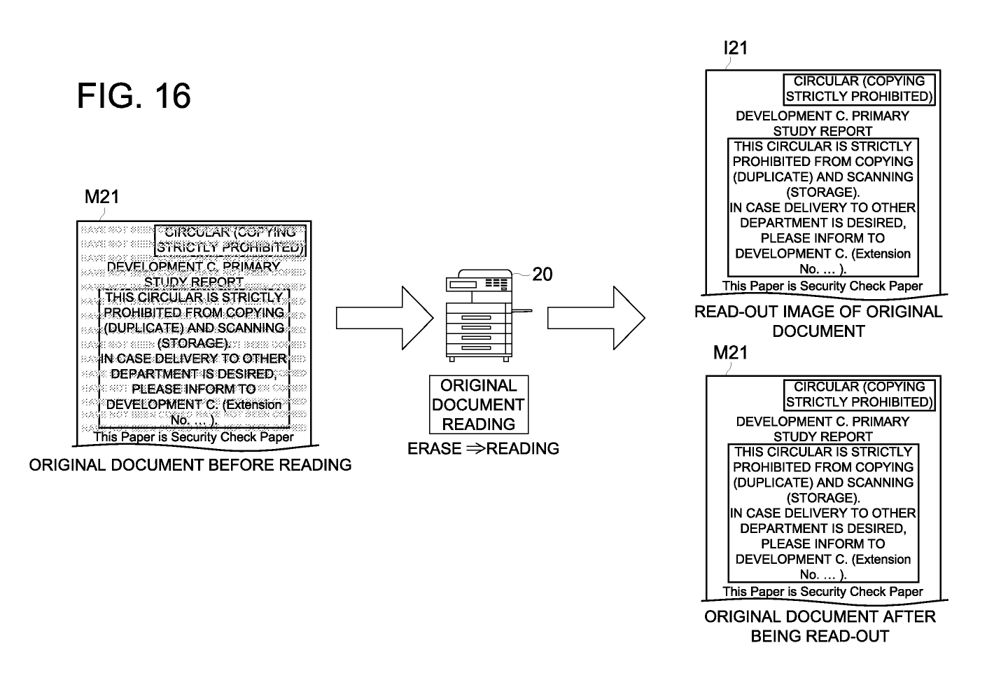

FIG. 16 illustrates a readout image 121 of original document M21 acquired in the case when MFP 20 reads out the printed material (printed material P21 in FIG. 15) added with the erasable mark and un-erasable mark as original document M21, and the original document M21 after having been readout. When MFP 20 reads out original document M21 with scanner section 32 by irradiating the specific wavelength light in the reading operations shown in FIG. 11, original document M21 erased of the erasable mark is readout. Accordingly, MFP 20 acquires readout image 121 with the un-erasable mark printed at the central position, and without the erasable mark. In original document M21 after having been readout, only the erasable mark is erased and the un-erasable mark remains in the central position.

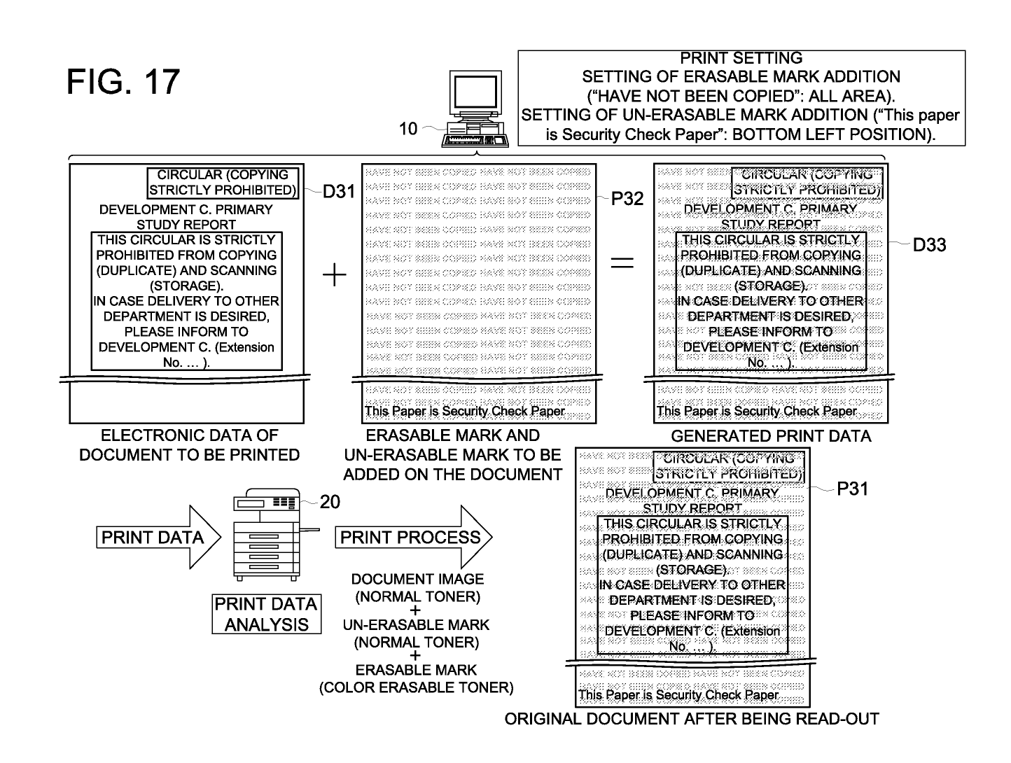

FIG. 17 is a drawing illustrating an example where adding position of the un-erasable mark is different from FIG. 15. In the present example, setting of adding the erasable mark (“HAVE NOT BEEN COPIED”) and the un-erasable mark (“This Paper is Security Check Paper”) is conducted in print setting of document (D31) at terminal apparatus 10, and the un-erasable mark is added at the lower left position (D32).

After terminal apparatus 10 generates and sends this print data (D33) to MFP 20, MFP 20 prints the image (document image and un-erasable mark arranged at the lower left of the document image) based the document data included in the print data in which the un-erasable mark is added at the lower left position by using the normal toner on the recording sheet, prints and outputs by superimposing the erasable mark by using the color erasable toner on said recording sheet (P31). In this printing process, order of printing by the normal toner or by the color erasable toner needs not be specified.

FIG. 16 illustrates a readout image 131 and original document M31 after having been readout, with respect to original document M31 acquired in the case when MFP 20 reads out the printed material P31 added with the erasable mark and un-erasable mark as original document M31 as shown in FIG. 17. When MFP 20 reads out original document M31 with scanner section 32 by irradiating the specific wavelength light in the reading operations shown in FIG. 11, original document M31 erased of the erasable mark is readout. Accordingly, MFP 20 acquires readout image 131 with the un-erasable mark printed at the lower left position, and without the erasable mark. In original document M31 after having been readout, only the erasable mark is erased and the un-erasable mark remains in the lower position.

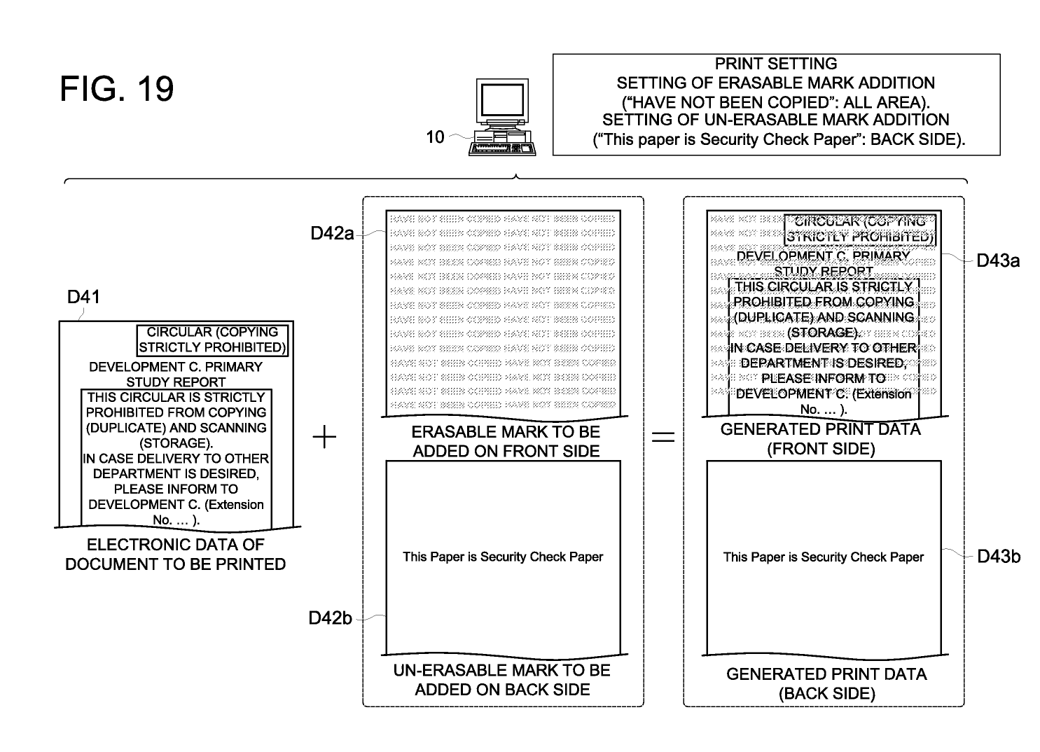

FIG. 19 is a drawing illustrating an example where the un-erasable mark is added on the back side. In the present example, setting of adding the erasable mark (“HAVE NOT BEEN COPIED”) and the un-erasable mark (“This Paper is Security Check Paper”) is conducted in print setting of document (D41) at terminal apparatus 10, and the erasable mark is added on the front side (print surface of the document image), and the un-erasable mark is added on the back side (D42b).

After terminal apparatus 10 generates and sends this print data (D43a and D43b) to MFP 20, although the illustration is omitted, MFP 20 prints the image based on the document data on the front side of recording sheet by use of the normal toner and print by superimposing the erasable mark on said front surface by use of the color erasable toner, and further prints and outputs the un-erasable mark at the central position on the back side of the recording sheet by use of the normal toner. In this printing process, order of printing by the normal toner or by the color erasable toner on the front side needs not be specified.

In cases where the above described printed material is used as an original document, MFP 20 reads out the original document erased of the erasable mark from the front surface with scanner section 32 by irradiating the specific wavelength light in the reading operations shown in FIG. 11. Accordingly MFP 20 obtains readout image of front side without erasable mark such as the readout image without the erasable mark similar to that shown in FIG. 10. In original document after having been readout, only the erasable mark is erased from the front side (refer to original document M1 after being readout in FIG. 10) and the un-erasable mark remains in the back side.

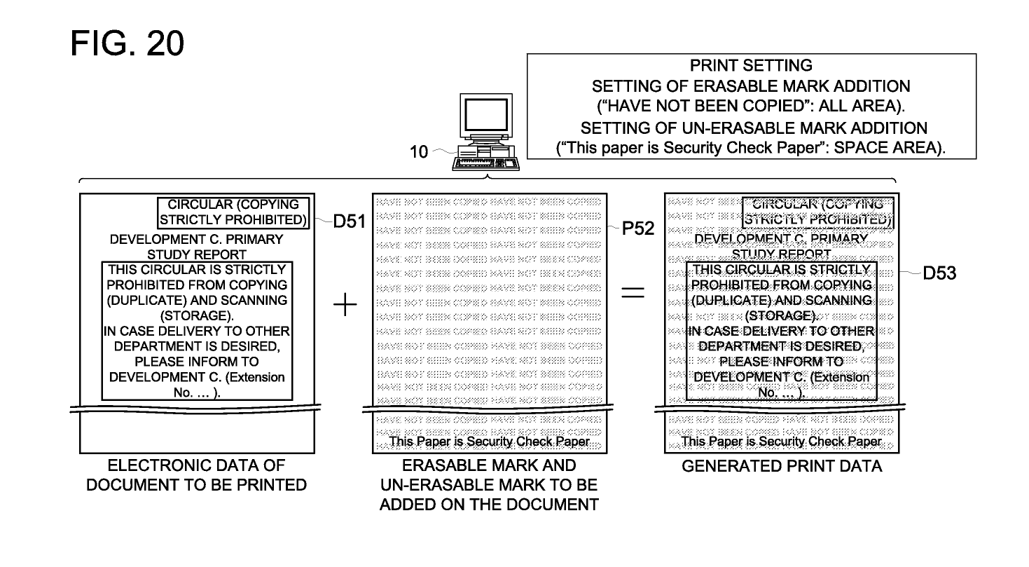

FIG. 20 is a drawing illustrating an example where the un-erasable mark is added at a space area of the printed material (document image). In the present example, setting of adding the erasable mark (“HAVE NOT BEEN COPIED”) and the un-erasable mark (“This Paper is Security Check Paper”) is conducted in print setting of document (D51) at terminal apparatus 10, and the un-erasable mark is added at the lower end position (D52) which being the space area. The space area is specified through an automatic search by printer driver 50 of terminal apparatus 10 analyzing the document image.

After terminal apparatus 10 generates and sends this print data (D53) to MFP 20, although the illustration is omitted, MFP 20 prints the image (document image and un-erasable image arranged at the lower end position of space area) based on the document data included in the print data added with the un-erasable mark at the lower end position on the recording sheet by use of the normal toner, and prints and outputs by superimposing the erasable mark on said recording sheet by use of the color erasable toner. In this printing process, order of printing by the normal toner or by the color erasable toner needs not be specified.

In cases where MFP 20 reads out the front surface of the above described printed material as an original document, MFP 20 reads out the original document erased of the erasable mark with scanner section 32 by irradiating the specific wavelength light in the reading operations shown in FIG. 11. Accordingly MFP 20 obtains readout image without the erasable mark, and with the un-erasable mark added at the lower end position. In original document after having been readout, only the erasable mark is erased and the un-erasable mark remains at the lower end position.

In this way, in the present embodiment, in case of printing (adding) the erasable mark on the printed material of the document required of printing from terminal apparatus 10 to MFP 20, or on the copied material (printed material) of the original document by MFP 20, the un-erasable mark, which has a function of display information indicating that said printed material be printed with the erasable mark, is printed by using the normal toner. On this printed material, the un-erasable mark remains without being erased, even when the erasable mark is erased in the case of being readout by MFP 20 irradiating specific wavelength light.

Accordingly, after the printed material has been readout, the fact that the erasable mark was printed on this printed material is easily determined by the printed material itself. For example, in cases where duplication is conducted while circulating a document strictly prohibited from duplication, a successive reader and the like can easily determine the fact of being illegally (improperly) duplicated during circulation from a state that the erasable mark does not exist and the un-erasable mark having a function of display information indicating that said printed material was printed with the erasable mark exists.

### Third Embodiment

In the second embodiment, the erasable mark to be printed by using the color erasable toner and the un-erasable mark to be printed by using the normal toner are respectively added on the printed material as separate marks, however in the third embodiment the case is described when both marks are combined to form a composite mark, and the composite mark is added on the printed material.

In the present embodiment, as an example of the composite mark configured with the erasable mark and the un-erasable mark, (1) ground pattern mark, (2) assimilated mark, and (3) non-assimilated mark will be explained in order, and finally (4) an example of a case where the assimilated mark and the non-assimilated mark is combined will be explained.

The ground pattern mark is a composite mark formed by combining such that one of the erasable mark or the un-erasable mark is formed to be a background (ground pattern), and the other is hidden by the background. The assimilated mark is a composite mark combined with assimilating the erasable mark and the un-erasable mark such that the boundary of the two marks is made to be inconspicuous. The ground pattern mark is included in this assimilated mark. Non-assimilated mark is a composite mark combined with the erasable mark and the un-erasable mark such that the boundary of the two marks is conspicuous and not assimilated.

Also in cases of adding these composite marks on the printed material, the addition is similarly executed as the print setting explained in the second embodiment. More specifically, in cases when a setting of adding the composite mark is executed through the print setting of the document by terminal apparatus 10, MFP 20 outputs a printed material of document image added with the composite mark based on the print data received from external apparatus. In cases where a setting of adding the composite mark is executed through the print setting of copying by MFP 20, terminal apparatus 10, MFP 20 outputs a duplicated material (printed material) of document image added with the composite mark.

(1) Ground Pattern Mark

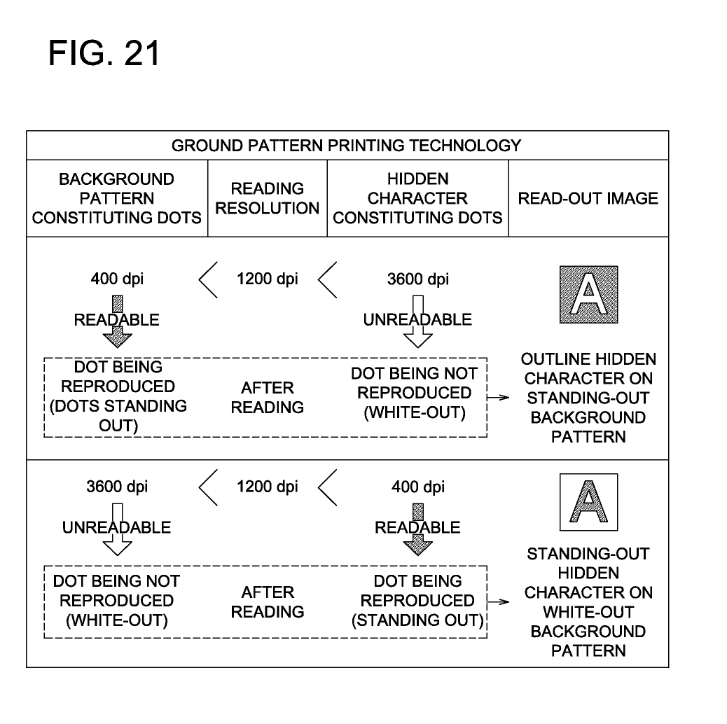

FIG. 21 is a diagram illustrating an outline of conventional ground pattern printing technology. The ground pattern printing technology is a printing technology when characters which appear by being duplicated (hidden characters) are inconspicuously embedded on a ground pattern constituting the background of printed material (background pattern), and when this printed material is duplicated by a coping machine and the like said hidden characters are made to appear on the duplicated material. Here, the image configured with the hidden characters embedded on the background pattern is referred as “ground pattern image”.

A principle of hidden character appearing by duplication is that by configuring one of the background pattern or the hidden characters in the ground pattern image with readable dots by a scanner and configuring the other with un-readable dots, the un-readable dots are made white-out, and the readable dots are made standing out in the image having been read (readout image). In the dot reading out process of scanner, dots having larger size than reading resolution of the scanner are readable (dots having size and density capable of being read by the scanner), and dots having a size smaller than the reading resolution of the scanner and less density (coarse pattern) than a prescribed density (a density that cannot be read by the reading resolution of the scanner) are un-readable. In order to inconspicuously embed the hidden character on the background pattern, these are preferably made with the same color.

As shown in FIG. 21, in cases where the reading resolution of the scanner is 1200 dpi for example, one of the background pattern or the hidden characters is configured with dots of 400 dpi which being larger than the reading resolution, and the other is configured with dots of 3600 dpi which being smaller than the reading resolution. In cases where dots configuring the background pattern are made larger and dots configuring the hidden characters are made smaller, only the background pattern is readout and reproduced to stand out and the hidden characters to white-out. On the contrary, in cases when dots configuring the background pattern are made smaller and dots configuring the hidden characters are made larger, the background pattern stands out and only the hidden characters are readout and reproduced to stand out.

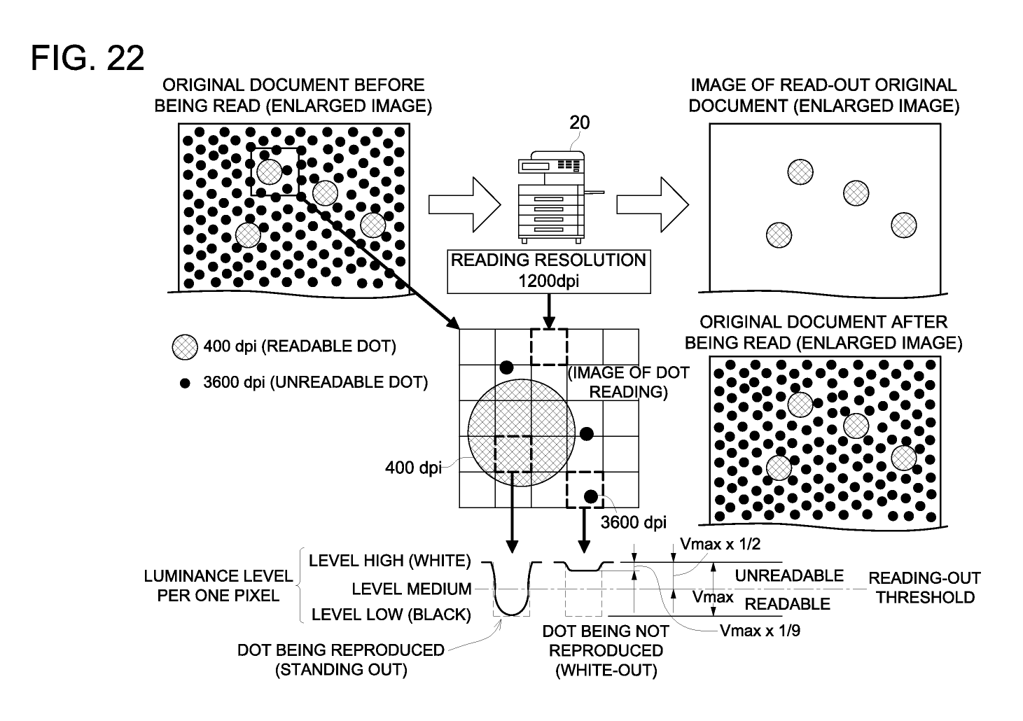

FIG. 22 is a diagram illustrating in enlarged image of the dots constituting each of the ground pattern image printed on an original document, the readout image of the original document, and the ground pattern image of the original document (ground pattern image) after having been read, in the conventional ground pattern printing technology.

The present diagram characteristically shows each type of dots for comparing each size of 400 dpi dots and 3600 dpi dots. For example, in the case where the original document shown in this diagram is printed by a MFP or a printer having print resolution of 3600 dpi, a single 400 dpi dot (dot corresponding to 400 dpi) is reproduced by congested plural 3600 dots. Here, in order to make the description easy to understand, the dot corresponding to 400 dpi formed with the congested plural 3600 dots is assumed to be a single 400 dpi dot, for explanation.

As shown in FIG. 22, for example, in the case where reading resolution of scanner 32 of MFP 20 is 1200 dpi, a luminance level per one dot in the reading sensor (line image sensor) for 400 dpi dot is outputted as low level, and for 3600 dpi dot is outputted as high level. More in detail, for a pixel, when 400 dpi dot exist to cover all area of the single pixel, the luminance level is outputted as the lowest level (Vmax) compared to a reference level. For a pixel, where a single 3600 dpi dot exists in the single pixel, the luminance level is outputted as the level approximately one-ninth of the lowest level (Vmax× 1/9).

In cases where reading-out threshold level of the reading sensor is set at a medium level, the 400 dpi dot is readout and reproduced in the readout image. The 3600 dpi dot is not readout and not reproduced in the readout image. More specifically, for a pixel, where less than 4.5 pieces of 3600 dpi dot exist in the single pixel, these 3600 dpi dots are not readout and not reproduced in the readout image. For a pixel, where 4.5 or more pieces of 3600 dpi dot exist in the single pixel, these 3600 dpi dots are readout and reproduced in the readout image. Further, in the original document after having been read, the state of ground pattern is not changed from that in the original document before reading.

The above-described dots, having a smaller size than the reading resolution of the scanner and less density than a prescribed density, is referred as dots for example having the density of less than 4.5 pieces of dots in a single pixel of the reading sensor, in cases where the reading resolution of the scanner is 1200 dpi and the reading threshold level by the reading sensor is set at the medium level as described above. Namely, the prescribed density in the condition exemplified in FIG. 22 is the density where 4.5 pieces of dots exist in a single pixel of the reading sensor.

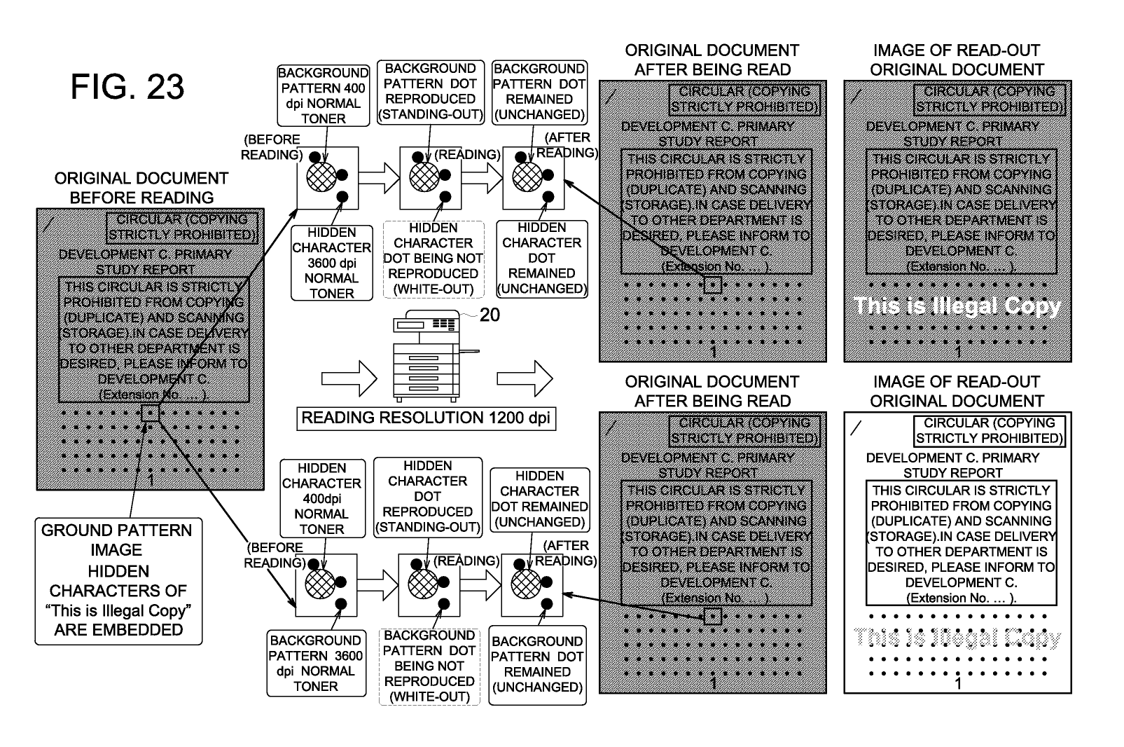

FIG. 23 is a diagram illustrating examples of the original document added with ground pattern image by a conventional printing technology, the readout image of this original document, and the original document after having been read.

For example, when the original document, where the hidden characters of “This is illegal copy” are embedded in the background pattern of the ground pattern, is readout by MFP 20, the hidden characters appear on the readout image. As explained in FIG. 21 and FIG. 22, in cases where the dots configuring the background pattern is made larger and the dots configuring the hidden characters is made smaller compared to the reading resolution of MFP 20 and dot density of the hidden characters is made smaller than the prescribed density, the background pattern appears to stand out and the hidden characters appears to be white-out. In cases where the dots configuring the background pattern is made smaller and the dots configuring the hidden characters is made larger compared to the reading resolution of MFP 20 and dot density of the background pattern is made smaller than the prescribed density, the background pattern appears to be white-out and the hidden characters appears to standout. Further, in the original document after having been read, the state of ground pattern is not changed from that in the original document before reading.

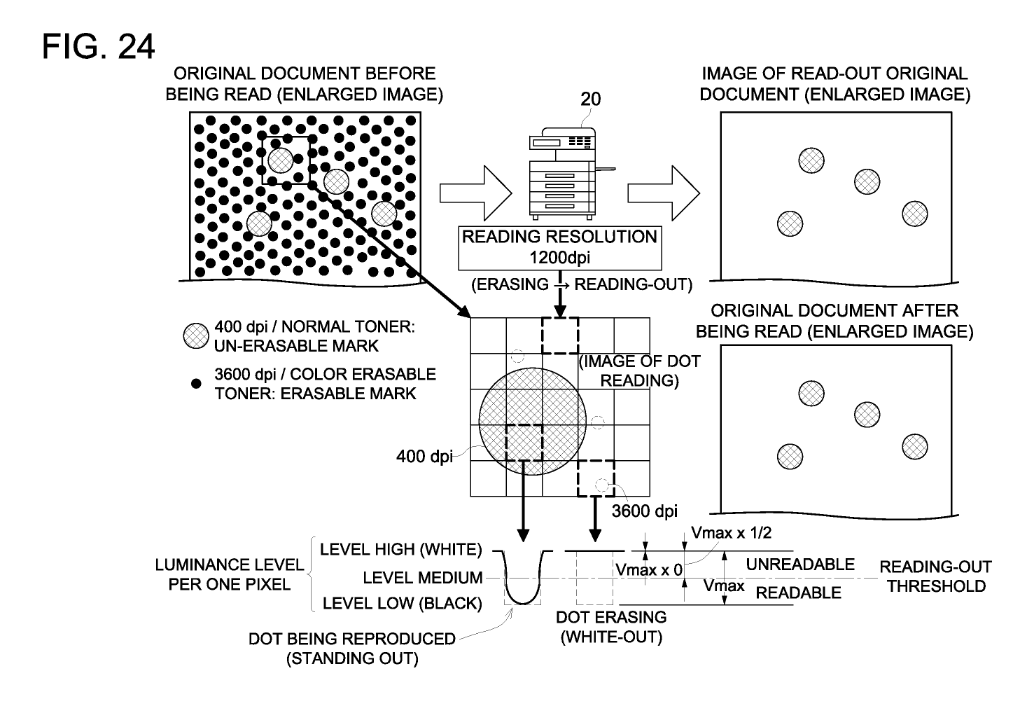

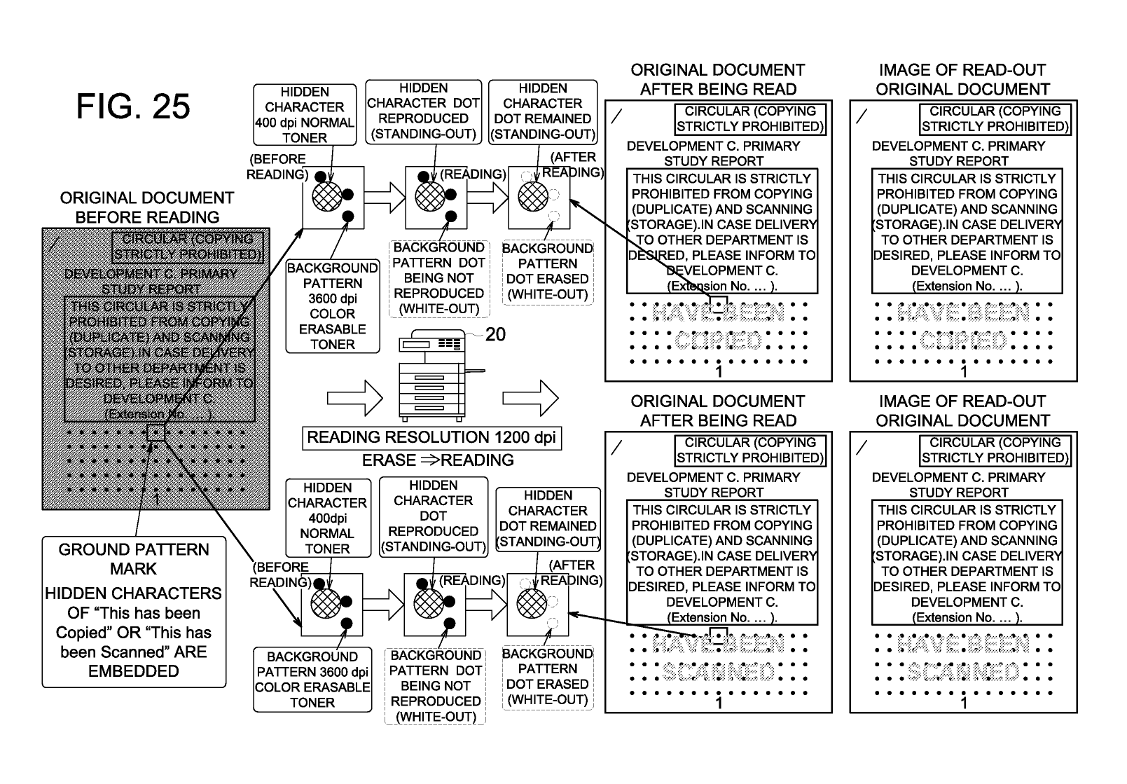

FIG. 24 is a diagram illustrating in enlarged image of the dots constituting each of the ground pattern image printed on an original document by the ground pattern printing technology relating to the present embodiment of the present invention, the readout image of the original document (ground pattern mark), and the ground pattern mark of the original document after having been read. FIG. 25 is a diagram illustrating examples of the original document printed with the ground pattern mark by the ground pattern printing technology relating to the present embodiment of the invention, the readout image of said original document, and the original document after having been read.

As described above, the ground pattern mark to be printed on the original document is a composite mark formed by combining such that one of the erasable mark to be printed by using the color erasable toner or the un-erasable mark to be printed by using the normal toner is formed to be a background (ground pattern) and the other is hidden by the background. Further the ground pattern mark is included in the assimilated mark when the erasable mark and the un-erasable mark are combined by assimilating such that the boundary of the two marks is made to be inconspicuous. Here, the case will be explained when the ground pattern mark is configured with hidden characters embedded in the background pattern similarly to the conventional ground pattern image.

For example, in cases where the reading resolution of scanner section 32 in MFP 20 is 1200 dpi, in the ground pattern mark, the background pattern is configured of an erasable mark constituted of unreadable 3600 dpi dots to be printed by using the color erasable toner, and the hidden characters are configured of an un-erasable mark constituted of readable 400 dpi dots to be printed by using the normal toner. Contents of the hidden characters are “HAVE BEEN COPIED”, “HAVE BEEN SCANNED”, and the like.

When MFP 20 reads out the original document printed with the above ground pattern mark by irradiating the specific wavelength light with scanner section 32 by the reading operation shown in FIG. 11, the image of original document is readout where the background pattern made of erasable mark is erased. Accordingly, MFP 20 obtains the readout image when the background pattern being white-out and the hidden characters configured of the un-erasable mark being standout. In the original document after having been readout, only the background pattern is erased to be whiteout, and the hidden characters become the state of standout.

Further, it is possible to configure the background patter in the ground pattern with the un-erasable mark (400 dpi dots with the normal toner) and the hidden characters with the erasable mark (3600 dpi dots with the color erasable toner). When the original document printed with this ground pattern mark is read by MFP 20, the original document image erased of the hidden characters made of the erasable mark is readout. Accordingly, MFP 20 obtains the readout image where the hidden characters being whiteout and the background pattern configured of the un-erasable mark being standout. In the original document after having been readout, only the hidden characters are erased to be whiteout, and the background pattern becomes the state of standout.

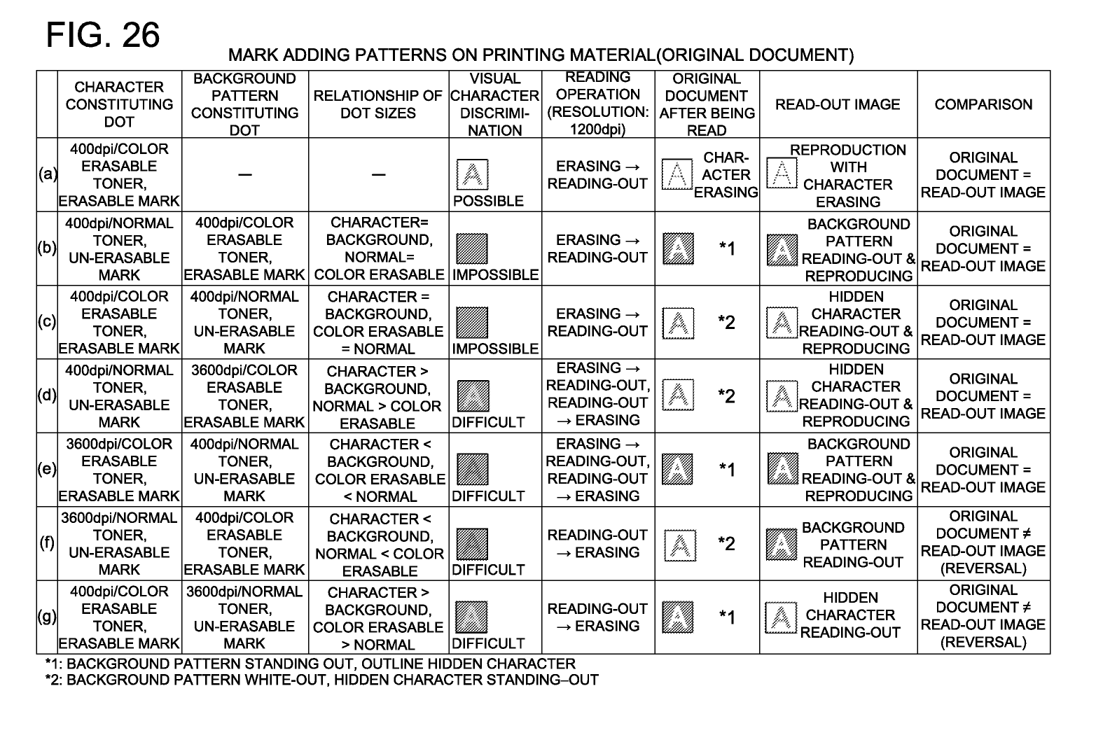

FIG. 26 is a diagram illustrating adding patterns in a view in cases where the erasable mark (characters) relating to the first embodiment of the present invention and the ground pattern mark (back ground pattern and hidden characters) relating to the third embodiment are added on the printed material. Specifically, for each adding pattern shown in view are: contents of dots constituting the characters/hidden characters, contents of dots constituting the background pattern, relationship of both dot sizes, possible or not of visual discrimination of characters/hidden characters on the original document before reading, order (or timing) of erasing and reading-out in the reading operation of MFP 20, state of the original document after having been read, readout image of the original document obtained by MFP 20, and comparison of the original after having been read and the readout image. In FIG. 26, the adding pattern of the first embodiment is shown in (a), and the adding pattern of the third embodiment is shown in (b)-(g).

In (a), as explained in the first embodiment, the characters to be printed on the printed material becomes the erasable mark. Among the ground pattern mark in (b)-(g), in (b), (d), and (f) the hidden characters to be printed on the printed mark by using the normal toner become the un-erasable mark, and the background pattern to be printed by the color erasable toner becomes the erasable mark In (c), (e), and (g), the hidden characters to be printed on the printed material by using the color erasable toner become the erasable mark, and the background characters to be printed by using the normal toner become the un-erasable mark.

Regarding the ground pattern mark in (b)-(g), in order to inconspicuously embed the hidden characters in the background pattern, it is preferable to make both characters with the same color. In particular, in order to embed the hidden characters completely inconspicuous, these are preferable configured with dots of continuous pattern. In (d) and (e), even when the order of erasing and reading out is reversed in the reading operation, the original after having been read and the readout image become same.

The ground pattern mark shown in FIGS. 24 and 25 is according to the adding pattern (d). The state of the original document after having been readout shown in FIG. 25 can be also realized by adding pattern (c).

In the adding patterns (f) and (g), in cases where the density of the un-erasable mark configured of 3600 dpi dots printed by the normal toner is made to be such the density (for example, less than 4.5 pieces per one pixel) that cannot be readout by MFP 20 whose reading resolution being 1200 dpi, and further by reversing the order of erasing and image reading from that in the reading operation explained with FIG. 11, the hidden characters in the original document after having been readout and the hidden characters in the readout image appear reversely with each other between standing out image and whiteout image. Accordingly, the original document after having been read can be easily discriminated from the printed material.

The size of dots configuring the un-erasable mark (character) in (a) is not limited to 400 dpi but may be the other sizes. Each size of dots configuring the erasable mark and the un-erasable mark in adding patterns (b) and (c) is not limited to 400 dpi but may be the other sizes if readable by the reading resolution of MFP 20 and each dot size is same with each other. Each size of dots configuring the erasable mark in adding patterns (d) and (e) is not limited to 3600 dpi but may be the other sizes if un-readable by the reading resolution of MFP 20. Each size of dots configuring the un-erasable mark in adding patterns (d) and (e) is not limited to 400 dpi but may be the other sizes if readable by the reading resolution of MFP 20. Each size of dots configuring the erasable mark in adding patterns (f) and (g) is not limited to 400 dpi but may be the other sizes if readable by the reading resolution of MFP 20. Each size of dots configuring the un-erasable mark in adding patterns (f) and (g) is not limited to 3600 dpi but may be the other sizes if un-readable by the reading resolution of MFP 20.

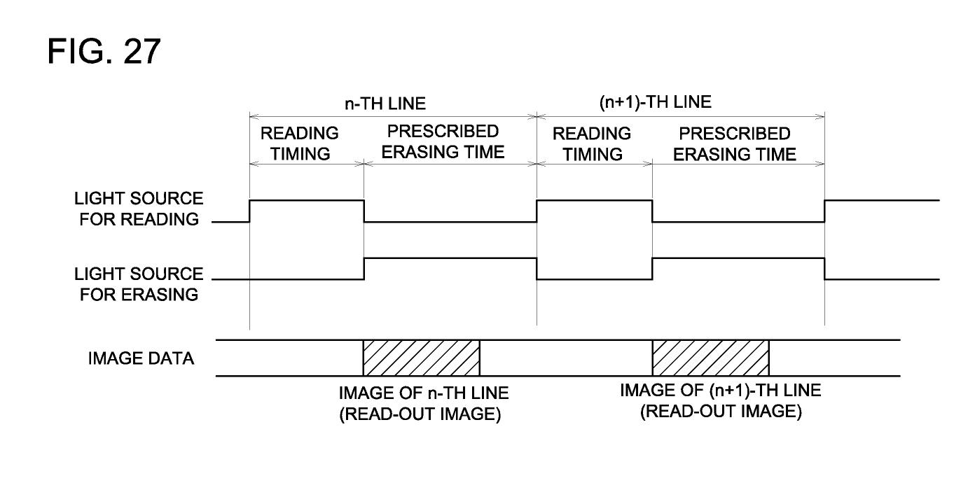

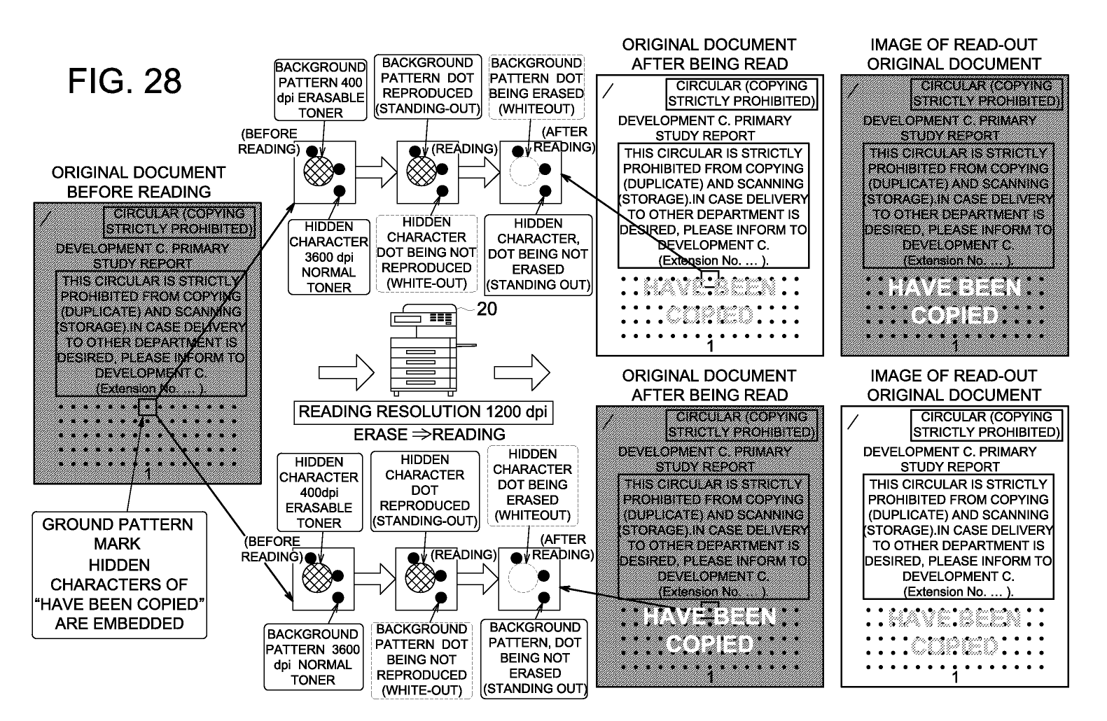

FIG. 27 is a timing chart showing the put-on/put-off timing of the light source and the reading-out timing of the original document in original document reading operation in the patterns (f) and (g) of FIG. 26. FIG. 28 is a diagram illustrating examples of the original document printed with a ground pattern mark of adding patterns (f) and (g) of FIG. 26, the readout image in the case where this original document is read by the reading operation shown with the timing chart of FIG. 27, and the original document after having been read.

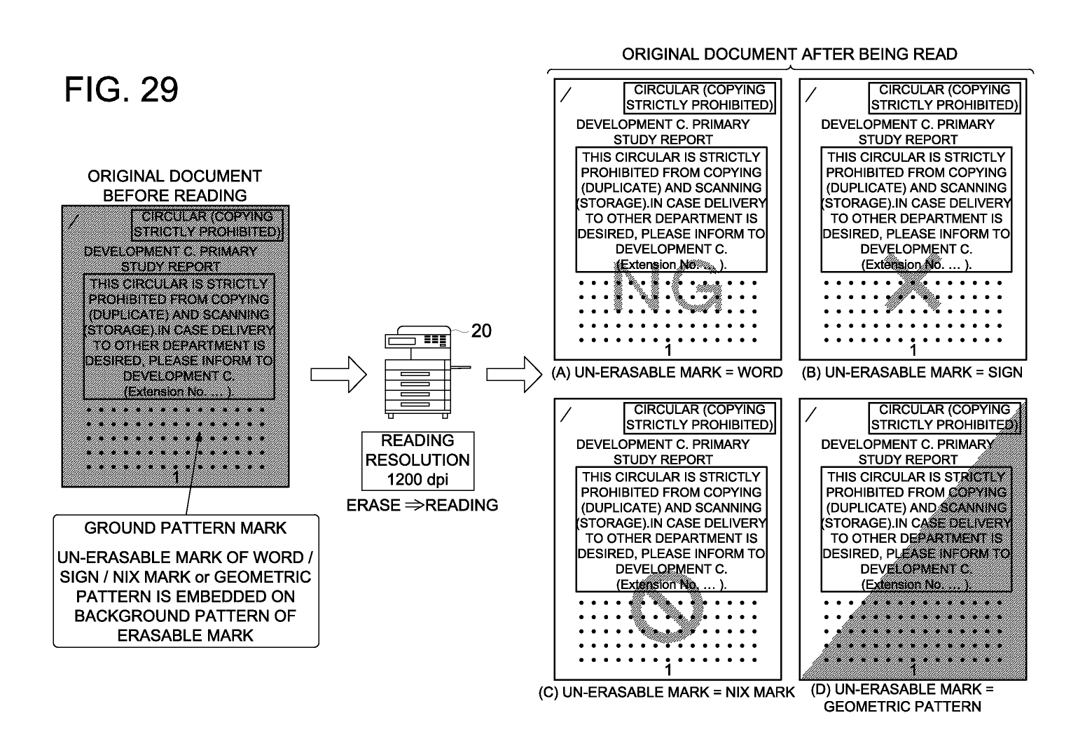

FIG. 29 is a diagram illustrating examples of various type of information inconspicuously embedded in hidden manner into the background pattern of the ground pattern mark. The information shown in these examples are (A) word (NG: abbreviation), (B) sign (X), (C) nix mark, and (D) geometric pattern. The ground pattern marks in this example are added to the original document (printed material) by the adding patterns (c) or (d) in FIG. 26, the background pattern being configured of the erasable mark, and the information being configured of the un-erasable mark. When the original document (printed material) added (printed) with the ground pattern mark of the present example is readout by MFP 20, the background pattern is erased from the original document after having been read, and the hidden information appears to standout.

Pieces of information shown by (A)-(D) in the present drawing are only examples, and the other pieces of information as word, sign, mark (abnormal mark), and geographic pattern may be applicable. In cases of using these pieces of information, it is preferable to use the information with which when a third person having not executed the reading out of original document views the original document (after having been readout), the person can easily recognizes something having been occurred on the original document. With respect to the adding patterns, not limiting to (c) or (d) in FIG. 26, (b), (e), (f) or (g) may be applied.

(2) Assimilated Mark

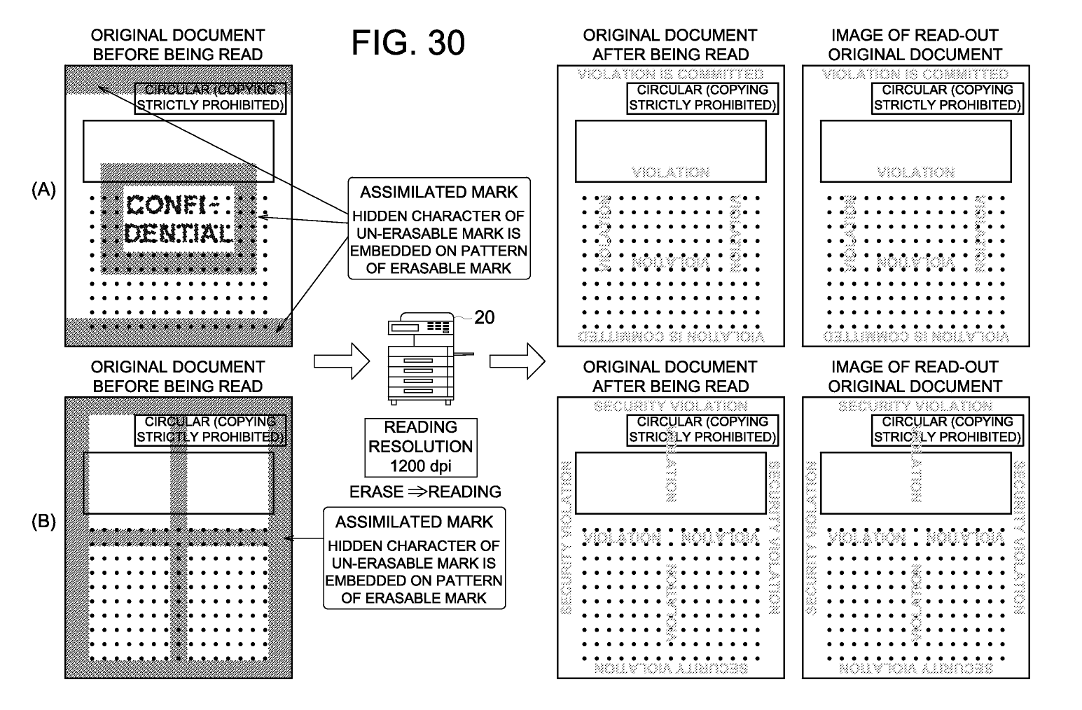

FIG. 30 is a drawing illustrating an example of the assimilated mark. As described above, the assimilated mark is a composite mark combined with assimilating the erasable mark and the un-erasable mark such that the boundary of the two marks is made to be inconspicuous.

The erasable mark and the un-erasable mark in the assimilated mark are, similarly to the ground pattern mark, added (printed) on the printed material by combining with assimilating such that the boundary of the two marks is made to be inconspicuous by utilizing the ground pattern printing technology (refer to (b)-(g) in FIG. 26) relating to the present embodiment. Difference from the ground pattern mark is that in contrast to the case of ground pattern mark when the background pattern being printed on all sheet area or most of the area in order to hide the information of characters and the like, in the case of assimilated mark pattern to hide the information of characters and the like is printed on only a partial area in order to reduce the toner consumption. The partial area may be an arbitral part such as a marginal part of the surface of recording sheet (upper marginal part, bottom marginal part, or side marginal part), a central part or an empty area of the image.

Explained here will be the latter mark of the ground pattern mark and the mark other than the ground pattern mark included in the assimilated mark, and specifically will be the non-ground pattern mark (mark other than the ground pattern mark) included in the assimilated mark.

In FIG. 30 (A) and (B), two assimilated marks (non-ground pattern mark) are exemplified. The assimilated mark in the present example is added on the original document (printed material) by the adding pattern of (c) or (d) in FIG. 26, the pattern added at a partial area of the sheet surface being configured with the erasable mark, and the information (hidden characters) embedded being hidden in the pattern being configured of un-erasable mark.

In the case of (A), the assimilated marks are added at the upper marginal part, the bottom marginal part and the central part. The assimilated marks at the upper and lower marginal parts are belt-like patterns where patterns configured of the erasable mark extend along the all region in width direction. At the diagonal positions in the upper and lower belt-like patterns, hidden characters of “VIOLATION IS COMMITTED” configured of the un-erasable mark are embedded. Specifically, at the upper right part of the original document, characters of “CIRCULAR (COPYING STRICTLY PROHIBITED)” are printed, and as the assimilated mark of upper marginal part the hidden characters are embedded at the upper side of the characters in the belt-like pattern. As the assimilated mark of lower marginal part, the hidden characters are embedded in the belt-like pattern. The total assimilated mark in the central part is configure of confidential mark, the pattern made of erasable mark being a rectangular belt pattern, and four sets of hidden characters made of the un-erasable mark (“VIOLATION”) are embedded at upper/lower/right/left positions in the rectangular belt pattern.

When MFP 20 reads the original document added with the assimilated mark of (A), as shown in the drawing in the original document after having been read, belt-like patterns in upper/lower marginal parts are erased and the hidden characters of “VIOLATION IS COMMITTED” appear with standout, and confidential mark in the central part is erased and the hidden characters of “VIOLATION” appear with standout. Especially, in the present example, in cases when the characters of “COPYING STRICTLY PROHIBITED” are printed at the upper marginal part of the original document, by making the characters such as “VIOLATION IS COMMITTED” appear in the vicinity of the characters of “COPYING STRICTLY PROHIBITED”, the third person can easily recognize that prohibited copy has been executed, when viewing the original document.

In the case of (B), the assimilated mark is a composite pattern configured with the erasable mark combined with a frame shaped pattern encircling the peripheral marginal part of the original document and cross-shaped pattern, and the un-erasable marks of hidden characters are embedded in six belts constituting the composite pattern. Specifically, in four belts constituting the frame pattern, the hidden characters of “SECURITY VIOLATION” are respectively embedded, and in two belts constituting the cross-shape, plural sets of characters of “VIOLATION” are respectively embedded.

When MFP 20 reads the original document added with the assimilated mark of (B), as shown in the drawing in the original document after having been read, the frame shaped pattern encircling the peripheral marginal part of the original document is erased and the hidden characters of “SECURITY VIOLATION” appear with standing out, and the cross-shaped pattern in the frame shaped pattern is erased and hidden characters of “VIOLATION” appear with standing out.

Further, in cases where the original document has been read halfway from any of upper/lower/right/left directions, either one of assimilated marks (A) and (B), erased portions are surely generated in the pattern configured with the erasable mark. Accordingly the fact of being scanned halfway is also distinguished. Further, even incases where only the central area of the original document is scanned by covering the peripheral parts of the original document or by shifting the set position of original document on platen glass 41, similarly to the above, erased portions are surely generated in the pattern of central area configured with the erasable mark. Thus the scanning of only the central area can be also distinguished.

The assimilated marks (not ground pattern mark) shown in (A) and (B) of FIG. 30 are only examples. The pattern may be changed to the other shape. As the hidden characters, similarly to the case of the ground pattern mark, information configured of word, sign, mark (nix mark abnormal mark, etc.), geometrical pattern and the like may be utilized. As for the adding pattern, similarly to the case of the ground pattern mark, pattern of (c), (d), (f), or (g) may be applied in addition to (c) and (d) of FIG. 26.

(3) Non-Assimilated Mark

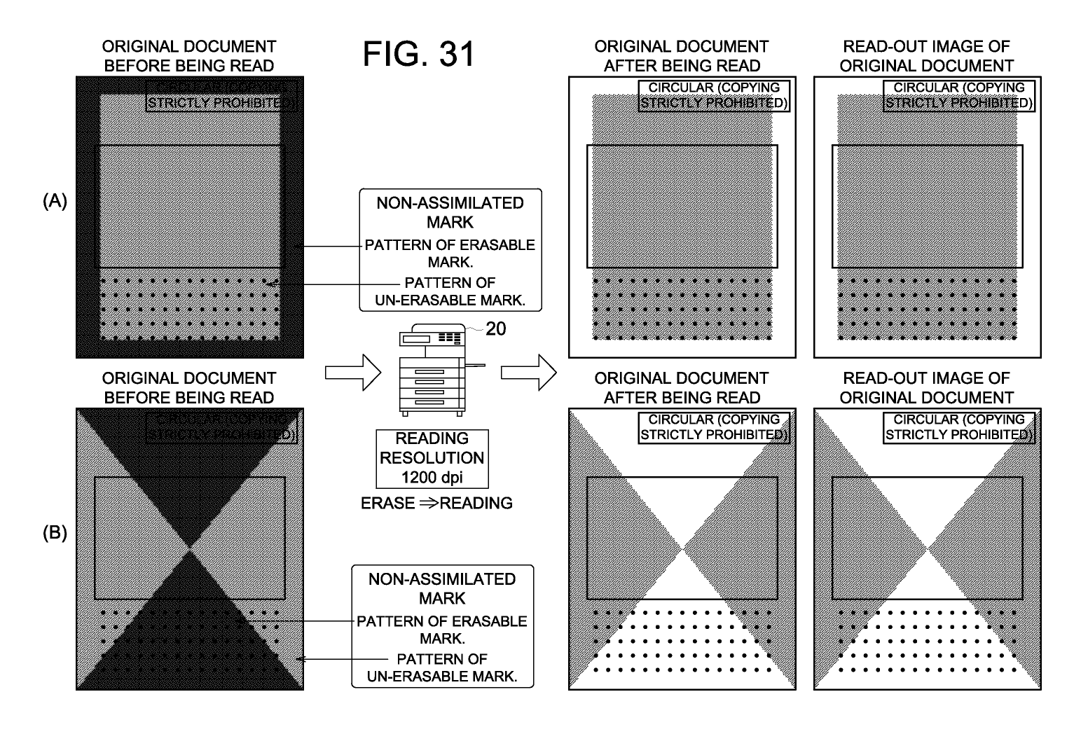

FIG. 31 is a drawing illustrating examples of non-assimilated marks. As described above, the non-assimilated mark is a mark configured by combining the erasable mark and the un-erasable mark without assimilating such that the boundary of both marks is distinguishable in view.

In the non-assimilated mark of (A), a pattern made of the erasable mark is configured with a frame shaped pattern encircling the peripheral parts of the original document, a pattern made of the un-erasable mark is configured with a rectangular pattern inscribed in the frame pattern, and both marks are combined without being assimilated such that the boundary is distinguishable in view.

When MFP 20 reads the original document added with the non-assimilated mark of (A), as shown in the drawing in the original document after having been read, the erasable mark of the frame shaped pattern encircling the peripheral marginal part of the original document is erased to be whiteout, and the un-erasable mark of the rectangular pattern remains, thus a change is caused against the state before having been read.

In the non-assimilated mark of (B), a pattern made of the erasable mark is configured with a pair of isosceles triangles residing in upper/lower regions among four isosceles triangles segmenting four regions in the original document, the un-erasable mark is configured with another pair of isosceles triangles residing in right/left regions, and both marks is combined without being assimilated such that the boundary is distinguishable in view.

When MFP 20 reads the original document added with the non-assimilated mark of (B), as shown in the drawing in the original document after having been read, the erasable mark of the pair of isosceles triangles residing in upper/lower regions is erased to be whiteout, and the un-erasable mark of the pair of isosceles triangles residing in right/left regions remains, thus a change is caused against the state before having been read.

Further, in cases where the original document has been read halfway from any of upper/lower/right/left directions, either one of the non-assimilated marks (A) and (B), erased portions are surely generated in the pattern configured with the erasable mark. Accordingly the fact of being scanned halfway is also distinguished.

The non-assimilated marks) shown in (A) and (B) of FIG. 31 are only examples. The pattern may be changed to the other shape such as a lattice pattern. Further, instead of combining each patterns, pattern and characters (including a word, and a sign), pattern and marks having various meaning (nix mark, abnormal mark, etc.) may be combined.

(4) Combination of Assimilated Mark and Non-Assimilated Mark

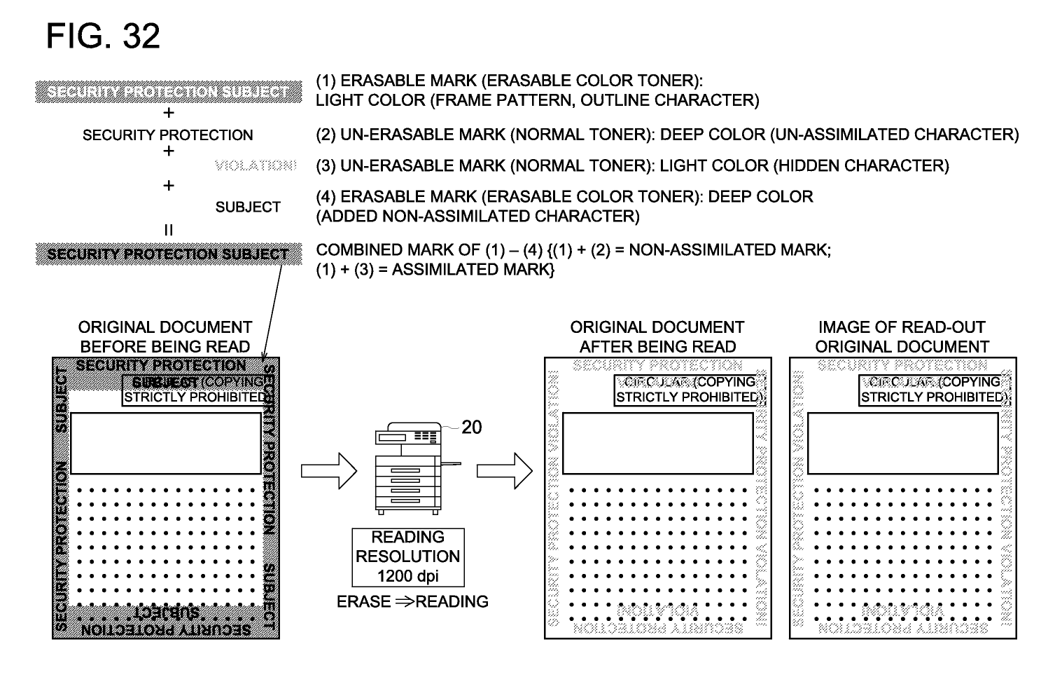

FIG. 32 is a drawing illustrating an example of a case where the assimilated mark and the non-assimilated mark are combined.

Both in the assimilated mark exemplified in FIG. 30 and the non-assimilated mark exemplified in FIG. 31, the erasable mark is configured with a pattern added on a partial area of the original document. In the present example described will be the case where this pattern is used as a common erasable mark in the assimilated mark and the non-assimilated mark, in addition to configuring the assimilated mark by embedding the un-erasable mark constituting hidden characters, configuring the non-assimilated mark by combining the un-erasable mark constituting non-assimilating characters with conspicuous border line, and further by combining the erasable mark constituting the characters being not assimilated to the common erasable mark, one composite mark is configured.

As shown in the original document before reading, the common erasable mark is configured with a frame shaped pattern using a light color. On the upper/lower/right/left bands of the frame shaped pattern, the un-erasable marks configured of characters “SECURITY PROTECTION” using a deep color are arranged with keeping a prescribed interval between each character, to configure the non-assimilated mark where these characters are combined without assimilating to the frame shaped pattern. Next to “SECURITY PROTECTION”, the UN-erasable mark configured of characters “VIOLATION” using a deep color are arranged with keeping a prescribed interval between each character, to configure the assimilated mark where these characters are embedded with assimilating to the frame shaped pattern. Further, between each character of “VIOLATION!”, the erasable mark configured of characters “SUBJECT” using a deep color are arranged character by character to configure a composite mark. In the frame shaped pattern, portions corresponding to each of the above-described characters are made whiteout, and the above-described characters are arranged at this whiteout portions.

In the original document added with the above-described composite marks (original document before reading), deep colored characters “SECURITY PROTECTION SUBJECT” being standout and conspicuous in view, in light colored frame-shaped pattern (belt pattern in upper/lower/right/left side). When MFP 20 reads this original document, in the original document after having been read, the frame-shaped pattern encircling the peripheral area (common erasable mark) and the characters “SUBJECT” are erased to be whiteout, and the characters “SECURITY PROTECTION” (un-erasable mark) remain, and further, the characters “VIOLATION!” having been hidden in the frame-shaped pattern appear, thus, characters of “SECURITY PROTECTION VIOLATION!” are formed. Namely, the characters “SECURITY PROTECTION SUBJECT” in the original document before reading are changed to “SECURITY PROTECTION VIOLATION!” in the original document after having been read.

In the present case, in cases where the original document has been read halfway from any of upper/lower/right/left directions, erased portions are surely generated in the frame-shaped pattern of erasable mark. Accordingly the fact of being scanned halfway is also distinguished.

In this way, according to the present embodiment, by printing the erasable mark and the un-erasable mark as one composite mark (unified mark), both marks can be added in the printed material as an image having few sense of strangeness.

Especially, the assimilated mark can be added on the printed material as a single mark hardly distinguishable in view of the erasable mark and the un-erasable mark. In image reading of this printed material, the erasable mark is erased by irradiation of specific wavelength light, and an unexpected un-erasable mark appears to cause a surprising change. For example, by generating the surprising change in the printed material having been read, a strong psychological effect may be given to admonish the injustice against an illegal image reading-out. Accordingly, recurrence inhibiting effect can be heightened against improper copying by reading the printed material. Further, by using the assimilated mark (not ground pattern mark) for printing at only a part of the sheet surface as exemplified in FIG. 30, or the composite mark including the assimilated mark and the non-assimilated mark as exemplified in FIG. 30, toner consumption can be suppressed.

Especially, according to the composite mark exemplified in FIG. 32, a sense of caution against copying or scanning can be given by displaying “SECURITY PROTECTION SUBJECT” in the original document before reading, to cause an inhibiting effect against duplication or storage. In cases when the copying or scanning is executed in violation, “SECURITY PROTECTION VIOLATION!” appears on the original document to show the evidence of improper operation, and this unexpected caution message gives a strong psychological effect to heighten a reference prohibiting effect.

Regarding the ground pattern mark, by combining the erasable mark and the un-erasable mark as one composite mark indistinguishable of both marks, the adding image (background image) having few sense of strangeness can be added on the printed material.

Regarding the assimilated mark including the ground pattern mark, in cases when the erasable mark and the un-erasable mark are configured with dots of same and continuous pattern, both marks can be added on the printed material as a visually indistinguishable single mark (such as a background pattern).

### Fourth Embodiment

In the fourth embodiment, specific operations to be executed in cases where the print setting of the erasable mark and the un-erasable mark explained in first and third embodiments is performed by terminal apparatus 10 will be described. Here, examples of print setting (security output setting) will be described in cases where printed materials explained in FIG. 5 to add the erasable mark as the background character, in FIG. 23 to add the conventional ground pattern mark, and in FIG. 25 to add the ground pattern mark by combining the erasable mark and the un-erasable mark are formed.

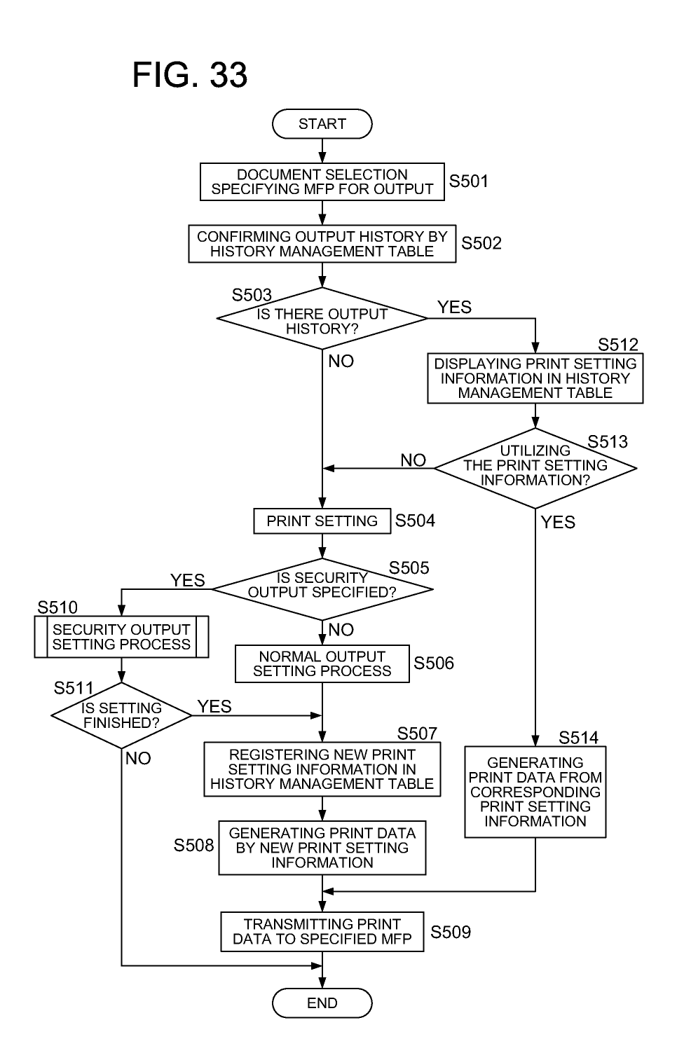

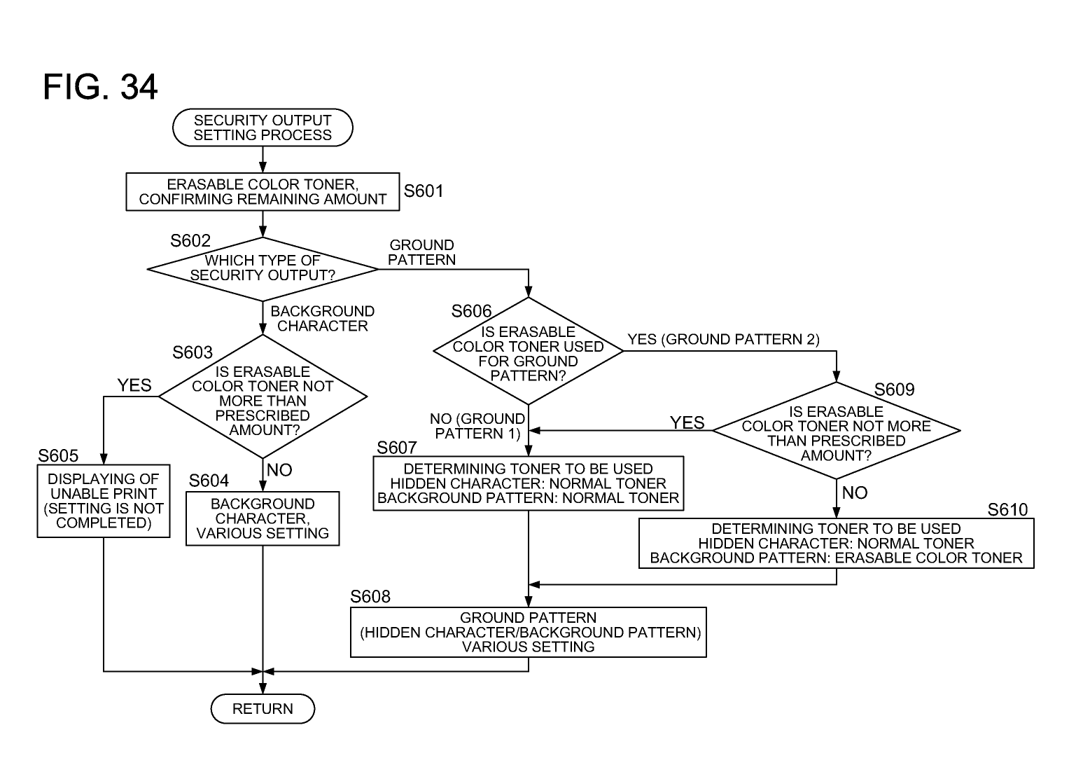

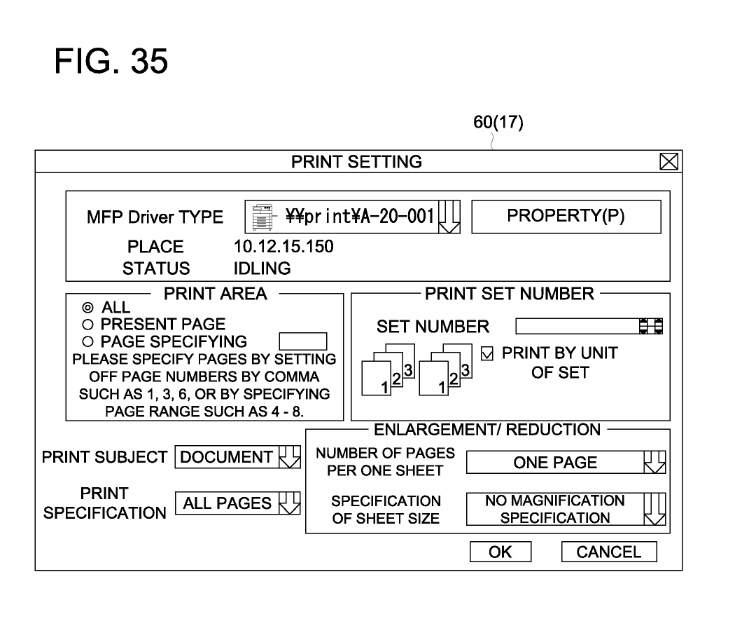

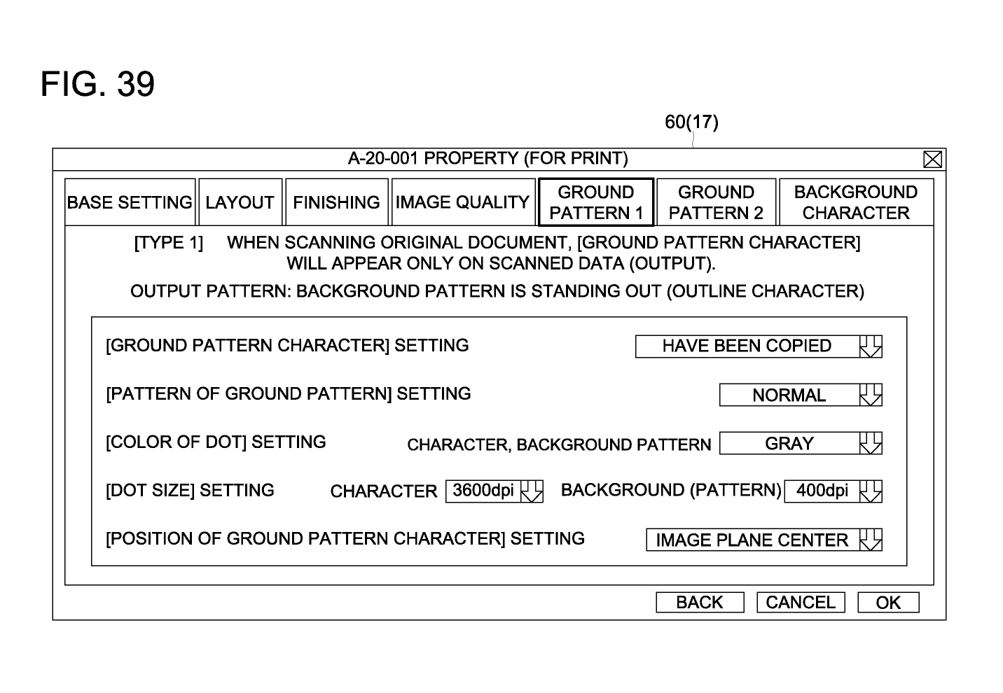

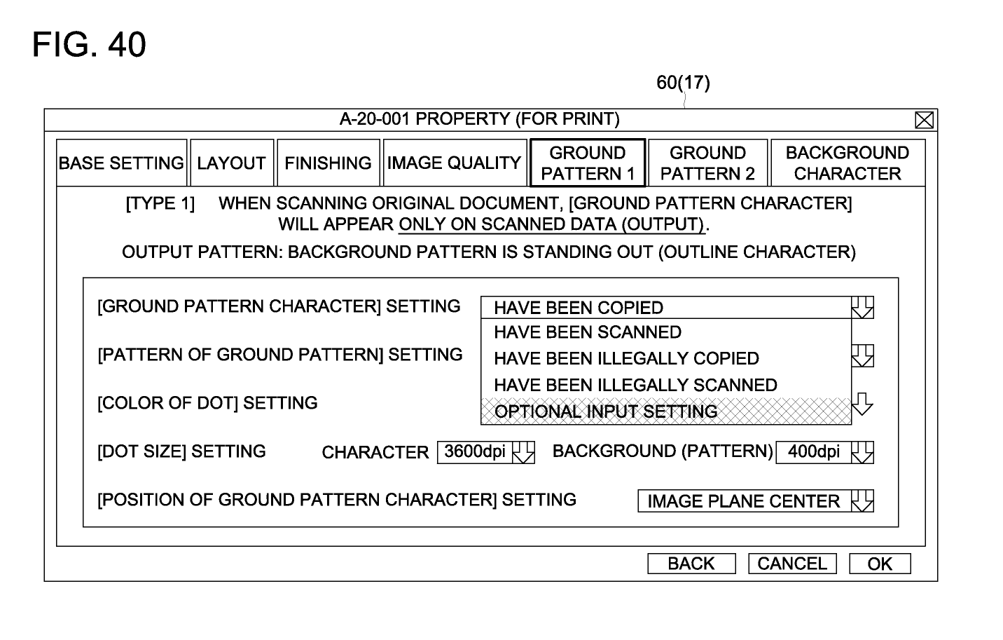

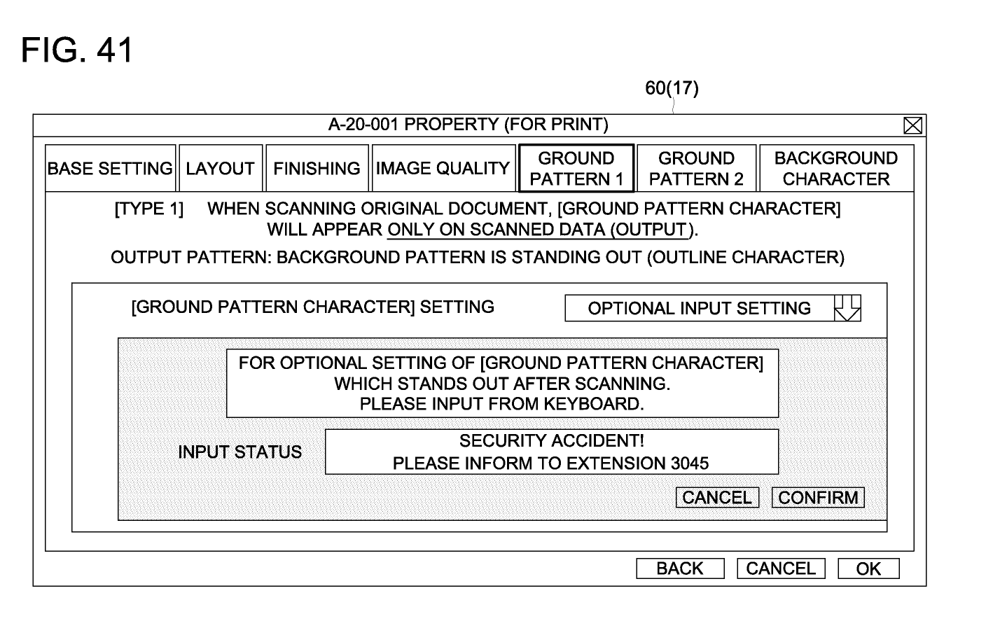

FIG. 33 is a flow chart showing a print request operation of a document by terminal apparatus 10 relating to the present embodiment. FIG. 34 is a flow chart showing the subroutine of security output setting process in the flow of FIG. 33. FIGS. 35-42 are diagrams illustrating examples of print setting screen 60 of printer driver 50 displayed on display section 17 of terminal apparatus 10.

As shown in FIG. 33, when terminal apparatus 10 receives the selection of document to be printed from a user through display section 17 and operation section 18 (step S501), CPU 11 confirms the output history of document by history management table 51 (step S502). In cases where there is no output history (step S503; No), CPU 11 (printer driver 50) displays print setting screen 60 (refer to FIG. 35) on display section 17, and receives the print setting through print setting screen 60 (step S504).

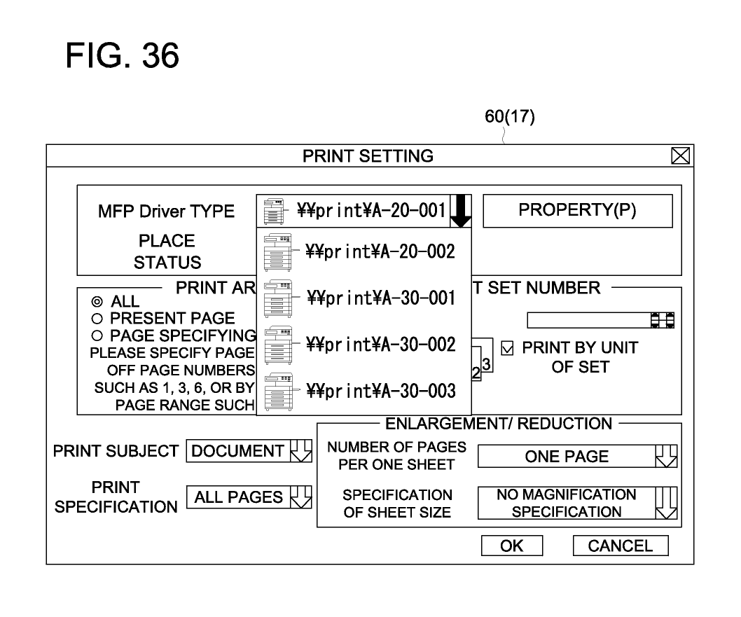

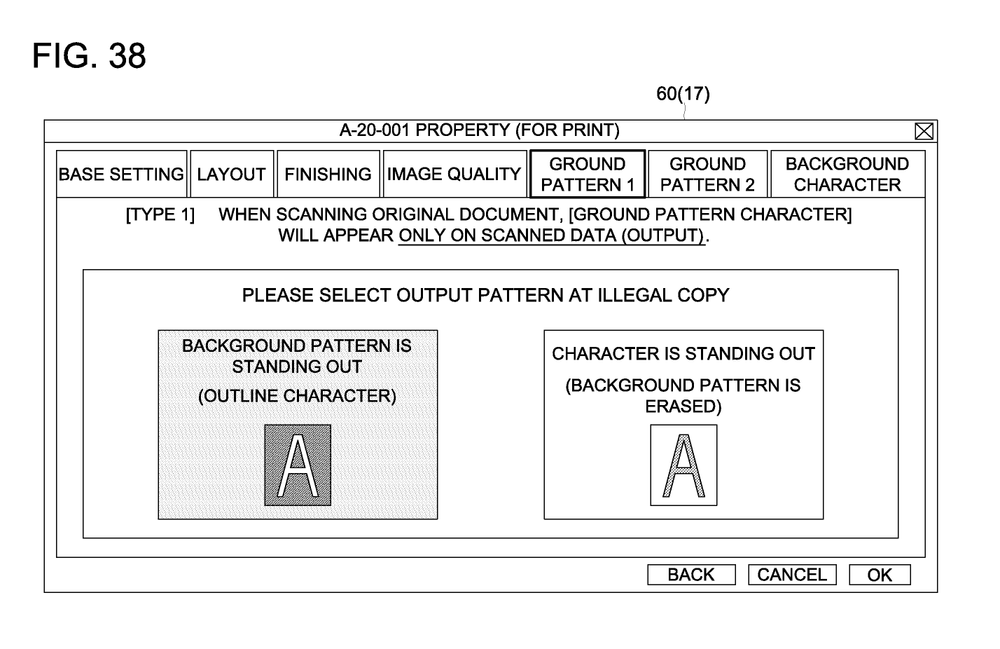

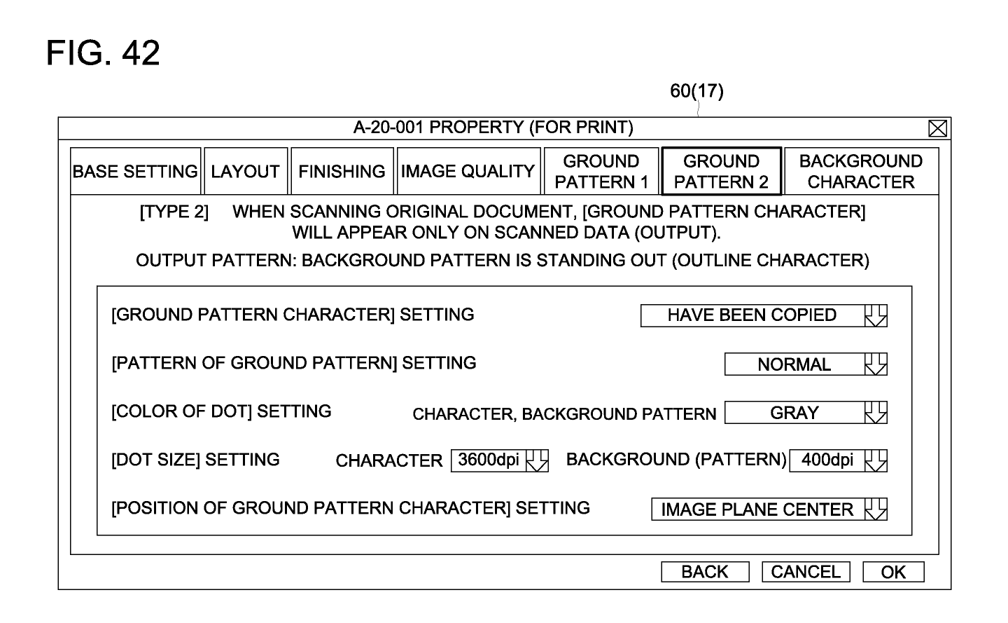

In the print setting, CPU 11 receives designation of MFP 20 for outputting (requested of printing) (refer to FIG. 36). Further, the user specifies security output as necessary. The security output specification is a setting of background characters that will be the erasable mark (refer to FIG. 37), a setting of hidden characters and background pattern constituting a ground pattern image by a conventional ground patter print technology (refer to FIGS. 38-41), or a setting of hidden characters (erasable mark) and background pattern (un-erasable mark) constituting the ground pattern described in the third embodiment (FIG. 42).

In cases where there is no security output designation (step S505; No), a normal output setting process relating to the received print setting is executed (step S506), and registers the print setting information by correlating to the selected document into a history management table 51 (step S507). For example, registers in the history management table 51 by correlating the document specifying information such as ID (identification information) and document name (file name) with the print setting information. The registration into history management table 51 may be done by correlating the document specifying information and updated time and date with the print setting information. And, by generating the print data that including the electronic data of the selected document and the print setting information (step S508), transmits to the specified MFP 20 (step S509/End).

In cases where there is a security output specification (step S505; Yes), CPU 11 executes a security output setting process (step S510). In cases where setting of the security output process is finished (step S511; Yes), proceeds to step S507. In cases when setting of the security output process is not finished (step S511; No), print instruction of the document is cancelled (End).

In cases where there is a security output designation (step S505; Yes), CPU 11 displays display section 27 the print setting information registered by correlating with the selected document in history management table 51 (step S512). In cases of receiving an instruction of using the print setting information from the user (step S513; Yes), by generating the print data including the electronic data of the selected document and the corresponding print setting information registered in history management table 51 (step S514), and transmits to MFP 20 indicated by the print setting information for outputting (step S509/End).

In the security output setting process shown in FIG. 34, CPU 11 inquires of MFP 20 via network communication section 19 about remaining color erasable toner amount for confirmation (step S601). MFP 20 inquired about the remaining color erasable toner amount from terminal apparatus 10 responds the detection result of whether the remaining amount of color erasable toner detected by remaining toner amount detector 34 is equal to or less than a prescribed amount.

In cases where a type of security output is the background character (step S602; background character), if the remaining color erasable toner amount is more than the prescribed amount (step S603; No), CPU 11 executes the print setting received via print setting screen 60 (refer to FIGS. 35-37), a setting of MFP 20 for output, and a setting relating to the print of background characters (step S604/Return). If the remaining color erasable toner amount is not more than the prescribed amount (step S603; Yes), CPU 11 does not execute the setting received via print setting screen 60, and displays on display section 17 to the effect that the security output printing with adding the background characters using the designated MFP 20 is unable (step S605/Return).

In cases where a type of security output is the ground pattern (step S602; ground pattern), if the ground pattern is the conventional ground pattern image that does not require the color erasable toner (step S606; No: refer to FIGS. 38-41), CPU 11 determines the toner to be used for the hidden characters in the ground pattern image and the background pattern as the normal toner (step S607). And, CPU 11 executes the print setting received via print setting screen 60 (refer to FIGS. 31, 32, and 34-37), a setting of MFP 20 for output, and a setting relating to the print of the ground pattern image (step S608/Return).

In cases of the ground pattern mark using the color erasable toner (step S606; Yes: refer to FIG. 42), if the remaining color erasable toner amount is not more than the prescribed amount (step S609; Yes), CPU 11 makes the ground pattern mark printed by replacing to the conventional ground pattern mark and determines the toner to be used for the hidden characters in the ground pattern image and the background pattern as the normal toner (step S607). And, CPU 11 executes the print setting received via print setting screen 60 (refer to FIGS. 35, 36, and 42), a setting of MFP 20 for output, and a setting relating to the print of the ground pattern image replaced to the conventional ground pattern image (step S608/Return).

If the remaining color erasable toner amount is more than the prescribed amount (step S609; No), CPU 11 determines the toner to be used for the hidden characters in the ground pattern mark as the normal toner, and the toner to be used for the background pattern as the color erasable toner (step S610). And, CPU 11 executes the print setting received via print setting screen 60 (refer to FIGS. 35, 36, and 42), a setting of MFP 20 for output, and a setting relating to the print of the ground pattern mark (step S608/Return).

According to the present embodiment, the setting of adding the erasable mark and the un-erasable mark on the image of document indicated in terminal apparatus 10, may be easily performed by using the print setting information previously set and stored.

In the above description, the embodiments of the present invention are explained by use of the drawings, however the specific configuration is not restricted to the embodiments. Changes and additions without departing from the scope of the concept of the present invention are included in the present invention.

The erasable mark (first mark) and the un-erasable mark (second mark) are switched between adding or not adding at the print setting for each printing or copying of original document, however not by switching for each printing or copying, automatic adding may be configured. For example, by providing a security mode that can be set in initial setting (administrator setting) or user setting at terminal apparatus 10 or MFP 20, the mark may be automatically set at printing or copying in the setting condition of the security mode.

According to this type of security mode, in cases for example, of continuously printing a plurality of documents as prohibited copying confidential documents at terminal apparatus 10, or in cases of continuously copying a plurality of original documents as a prohibited copying confidential document at MFP 20, the setting of the mark addition need not be conducted for each print or copy, which being convenient. Further it is useful in cases of utilizing terminal apparatus 10 exclusively for security printing, or in cases of utilizing MFP 20 exclusively for security copying.

Further, the image indicated to be printed is not restricted to be printed by using only the normal toner. For example a configuration may be possible where by specifying a part of the image at print setting, and the specified part is printed by using the erasable toner. According to this configuration, by setting the area when particularly high confidential information is described in the image for printing to be the area of being printed by using the erasable toner, even in cases where this image is improperly copied, the highly confidential information printed with the erasable toner is erased at the time of coping without being copied, thus information leak can be prevented.

As for the printing material whose color is erasable, the color erasable toner in an electrophotographic printing apparatus is exemplified, however, an erasable ink, whose color is erasable by irradiation of specific wavelength light, for inkjet system can be also utilized.

According to the print data generation apparatus, the printing apparatus and the program of the present invention, a printed material can be formed when the fact that reading is executed by an image reading apparatus to irradiate specific wavelength light on the original document at the time of reading the original document image is distinguished by the printed material of the original document itself. Thus, duplication by image reading of the original document can be restrained.

Further, as the printing apparatus relating to the present invention, not limiting to the multi functional peripheral, a copying machine or a scanner machine may be applicable.

What is claimed is:

1. A print data generation apparatus for generating a print data which causes an image indicated to be printed and a first mark to be printed on a same recording sheet,
wherein the first mark is printed by using a color erasable print material whose color is erasable by exposing to specific wavelength light.

2. The print data generation apparatus of claim 1, wherein the print data further causes a second mark, being printed by using a color un-erasable print material whose color is not erasable by exposing to the specific wavelength light, to be printed on the same recording sheet.

3. The print data generation apparatus of claim 2, wherein the print data causes to configure a single composite mark by combining the first mark and the second mark.

4. The print data generation apparatus of claim 3, wherein the composite mark includes an assimilated mark which is a composite mark combined with assimilating the first mark and the second mark such that the boundary of said two marks is made to be inconspicuous.

5. The print data generation apparatus of claim 4, wherein the composite mark includes a ground pattern mark formed by combining the first mark and the second mark such that one of the first mark or the second mark is made to be a background, and the other is hidden by the background.

6. The print data generation apparatus of claim 2, wherein one of the first mark or the second mark is configured with dots having a size and a density capable of being read with a prescribed reading resolution, and the other is configured with dots having a size and a density incapable of being read by the reading resolution.

7. The print data generation apparatus of claim 4, wherein the first mark and the second mark are configured with dots of a same and continuous pattern.

8. The print data generation apparatus of claim 2, wherein the second mark is an indication mark indicating that the erasable mark has been printed on the recording sheet.

9. The print data generation apparatus of claim 1, wherein in a print setting of the image, in cases of receiving a setting relating to printing of the first mark, the apparatus stores print setting information indicating the setting by correlating to the image, and at a next or later print setting of the image, the apparatus makes the print setting information stored in correlation to the image usable.

10. A printing apparatus comprising:
a print data generation apparatus for generating a print data which causes an image indicated to be printed and a first mark to be printed on a same recording sheet; and
a printing section for printing the image and the first mark on the same recording sheet, based on the print data generated by the print data generating apparatus,
wherein the first mark is printed by using a color erasable print material whose color is erasable by exposing to specific wavelength light.

11. The printing apparatus of claim 10, wherein
the print data generation apparatus generates the print data which further causes a second mark, being printed by using a color un-erasable print material whose color is not erasable by exposing to the specific wavelength light, to be printed on the same recording sheet; and
the printing section prints the image, the first mark printed by using a color erasable print material, and the second mark printed by using a color un-erasable print material, on the same recording sheet, based on the print data generated by the print data generating apparatus.

12. A computer-readable recording medium recorded thereon a program for causing a computer to perform a function of the print data generation apparatus for generating a print data which causes an image indicated to be printed and a first mark to be printed on a same recording sheet,
wherein the first mark is printed by using a color erasable print material whose color is erasable by exposing to specific wavelength light.

13. A computer-readable recording medium of claim 12, wherein the print data further causes a second mark, being printed by using a color un-erasable print material whose color is not erasable by exposing to the specific wavelength light, to be printed on the same recording sheet.
